(19) United States
(12) Patent Application Publication
(10) Pub. No.: US 2026/0022020 A1
(43) Pub. Date: Jan. 22, 2026

(54) PROCESSES AND SYSTEMS FOR MAKING RENEWABLE GRAPHITE FROM BIOMASS-DERIVED LIQUIDS

(71) Applicant: Carbon Technology Holdings, LLC, Oakdale, MN (US)

(72) Inventors: Edgar LOTERO, Overland Park, KS (US); Dustin SLACK, Gwinn, MI (US); Daren DAUGAARD, Newburg, MO (US); James A. MENNELL, Brighton, UT (US)

(21) Appl. No.: 19/272,646

(22) Filed: Jul. 17, 2025

Related U.S. Application Data
(60) Provisional application No. 63/673,623, filed on Jul. 19, 2024.

(51) Int. Cl. C01B 32/205; H01M 4/587

(52) U.S. Cl. CPC C01B 32/205; H01M 4/587; C01P 2006/40

(57) ABSTRACT

A process for producing a renewable biocoke product from a bioliquid feedstock comprises: feeding a bioliquid feedstock and recycled biocoke into a biocoking reactor; feeding a reducing gas into the biocoking reactor; chemically converting the bioliquid feedstock into biocoke by thermally cracking the bioliquid feedstock and nucleating biocoke on template particles of the recycled biocoke, wherein the reducing gas reacts with oxygen present in the bioliquid feedstock; within a devolatilization unit, devolatilizing the biocoke to generate a devolatilized biocoke; within a calcination unit or the devolatilization unit, calcining the devolatilized biocoke to generate a calcined biocoke; recovering biocoke, devolatilized biocoke, and/or calcined biocoke as recycled biocoke; and recovering the calcined biocoke as a renewable biocoke product. The renewable biocoke product may contain a high concentration of crystalline graphite, which is very useful in electrodes, such as in lithium-ion battery electrodes or in electric arc furnace electrodes for making steel.

### PRIORITY DATA

This non-provisional patent application claims priority to U.S. Provisional Patent App. No. 63/673,623, filed on Jul. 19, 2024, which is hereby incorporated by reference.

### FIELD OF THE INVENTION

The present invention generally relates to processes and systems for making and using graphite, and graphite compositions obtained from the disclosed processes and systems.

### BACKGROUND OF THE INVENTION

Carbon is a platform element in a wide variety of industries and has a vast number of chemical, material, and fuel uses. Carbon is a good fuel to produce energy, including electricity. Carbon also has tremendous chemical value for various commodities and advanced materials, including metals, metal alloys, composites, carbon fibers, electrodes, and catalyst supports. For metal making, carbon is useful as a reactant, for reducing metal oxides to metals during processing; as a fuel, to provide heat for processing; and as a component of a metal alloy. Historically, carbon in the form of coal has been used extensively for industrial purposes. Coal is still the world's largest source of energy for electricity generation and for metal making. However, coal is believed to be the single largest contributor to the climate crisis.

Carbon can be produced, in principle, from virtually any carbonaceous material. Carbonaceous materials commonly include fossil resources such as natural gas, petroleum, coal, and lignite; and renewable resources such as lignocellulosic biomass and various carbon-rich waste materials. It is preferable to utilize renewable biomass to produce carbon-based reagents because of the rising economic, environmental, and social costs associated with fossil resources.

Biomass is a term used to describe any biologically produced matter, or biogenic matter. The chemical energy contained in biomass is derived from solar energy using the natural process of photosynthesis. Photosynthesis is the process by which plants take in carbon dioxide and water from their surroundings and, using energy from sunlight, convert them into sugars, starches, cellulose, hemicellulose, and lignin. Of all the renewable energy sources, biomass is unique in that it is, effectively, stored solar energy. Furthermore, biomass is the only renewable source of carbon.

There exist a variety of conversion technologies to turn biomass feedstocks into high-carbon materials. Pyrolysis is a process for thermal conversion of solid materials in the complete absence of oxidizing agent (air or oxygen), or with such limited supply that oxidation does not occur to any appreciable extent. Depending on process conditions and additives, biomass pyrolysis can be adjusted to produce widely varying amounts of gas, liquid, and solid. Historically, slow pyrolysis of wood has been performed in large piles, in a simple batch process, with no emissions control. Traditional charcoal-making technologies are energy-inefficient as well as highly polluting.

Carbon has several allotropes, or forms. Important allotropes of carbon include graphite, graphene, fullerenes, diamond, and amorphous carbon. Graphite and graphene have a hexagonal crystal structure; graphene is essentially a single layer of graphite. Fullerenes have a spherical, tubular, or ellipsoidal crystal structure. Diamond has a diamond cubic crystal structure with a tetrahedral geometry. Amorphous carbon is carbon that has no crystalline structure.

Graphite is a mineral composed of stacked sheets of carbon atoms. Graphite is very soft, has a low specific gravity, is relatively non-reactive, and has high electrical and thermal conductivity. Graphite is the most stable form of pure carbon under standard conditions. The carbon in graphite is sp²-hybridized. Each carbon atom is joined to three other carbon atoms by covalent bonds. The carbon atoms form layers with a hexagonal arrangement of atoms. The molecular geometry of graphite is trigonal planar with a bond angle of 120°.

Graphite is one of the most versatile non-metallic minerals in the world. Conventionally, graphite is mined from the earth. Graphite occurs naturally in igneous and metamorphic rocks, where high temperatures and pressures and immense periods of time have converted organic material included in mineral deposits into graphite. Graphite is mined in China, Bavaria, South Korea, Russia, Canada, Norway, India, Sri Lanka, Mexico, Mozambique, and Madagascar. Today, China is the world's top graphite producer.

Graphite can also be created synthetically by heating materials with high carbon content, conventionally petroleum coke or coal-tar pitch. The carbon-rich material is heated up to about 3000° C., purifying the material of contaminants and allowing the carbon to form its hexagonal sheets at chemical equilibrium. On average, production of synthetic graphite emits more greenhouse gases than mining natural graphite (source: https://news.northwestern.edu/stories/2023/02/domestic-graphite-production-green-energy-transition, accessed on Dec. 5, 2023).

Graphite is considered a key, strategic material in the green economy including energy storage, electric vehicles, photovoltaics, and electronics. Demand for graphite is expected to outstrip supply over the next decade. Notably, there is an order of magnitude more graphite than lithium in most Li-ion batteries. For the electric-vehicle market, graphite demand is anticipated to soon exceed more than is produced globally today. Graphite usage in lithium-ion batteries, stationary batteries, lead-acid batteries, and fuel cells is expected to increase five-fold by 2050 under a scenario that limits global warming to two degrees Celsius. See Zhang et al., “Graphite Flows in the U.S.: Insights into a Key Ingredient of Energy Transition”, Environ. Sci. Technol. 2023, 57, 3402-3414, which is hereby incorporated by reference.

Graphite is used as a dry lubricant in applications where wet lubricants, such as oil, cannot be used. Graphite has been used in pencil lead since the 1600s. Graphite is used to make brake linings. Graphite is the only non-metal element that is a good conductor of electricity. As noted above, graphite electrodes are common in many types of batteries, as well as fuel cells. Graphite electrodes are used in electric arc furnaces for the steel production process. Large electrical currents are passed through the graphite electrodes, and electric arcs form between the tips of the electrodes and across the liquid steel. Natural graphite is used as molds in refractory applications that involve extremely high heat and therefore demand materials that will not melt or disintegrate under such extreme conditions. One example is a crucible used in the steel industry. Graphite is also used as a neutron moderator in nuclear reactors. Graphite is also used in other core energy transition products, such as silicon for solar panels and rotor blades and electric brushes for wind turbines. Specialty graphite is used in semiconductor production. Graphite demand is also increasing for other advanced technologies including aerospace applications, ceramic armor tiles, and electro-consolidation (Zhang et al., op. cit.).

In view of the growing demand for graphite, there is a desire for more sustainable and renewable processes and systems for making graphite. In particular, there is a desire to avoid mining rocks of natural graphite, and to avoid using fossil-fuel feedstocks to make synthetic graphite.

### SUMMARY OF THE INVENTION

The present invention addresses the aforementioned needs in the art.

In some variations, the invention provides a process for producing a renewable biocoke product from a bioliquid feedstock, the process comprising:
(a) providing a bioliquid feedstock;
(b) providing a recycled biocoke;
(c) feeding the bioliquid feedstock and the recycled biocoke into a biocoking reactor;
(d) feeding a reducing gas into the biocoking reactor, wherein the reducing gas contains H₂ and/or CO;
(e) within the biocoking reactor, chemically converting the bioliquid feedstock into biocoke by thermally cracking molecules of the bioliquid feedstock and nucleating the biocoke on particles of the recycled biocoke as a biocoking template, wherein the reducing gas reacts with at least some oxygen present in the bioliquid feedstock to form H₂O and/or CO₂;
(f) within a devolatilization unit, devolatilizing the biocoke to generate a devolatilized biocoke;
(g) within a calcination unit, or within the devolatilization unit, calcining the devolatilized biocoke to generate a calcined biocoke;
(h) recovering a portion of the biocoke, a portion of the devolatilized biocoke, a portion of the calcined biocoke, or a combination thereof, as the recycled biocoke for use in step (b); and
(i) recovering the calcined biocoke as a renewable biocoke product.

In some embodiments, the bioliquid feedstock is obtained from condensing and optionally fractionating a pyrolysis vapor from biomass pyrolysis.

In some embodiments, the bioliquid feedstock and the recycled biocoke are pre-mixed in a heated mixing unit prior to feeding to the biocoking reactor.

In some embodiments, the reducing gas is obtained from collecting and optionally fractionating and/or treating a non-condensable gas stream from biomass pyrolysis.

In some embodiments, the reducing gas contains at least some H₂. A portion of the H₂ may react with aromatic groups within the bioliquid feedstock or within the biocoke. The reaction of the H₂ with organics may assist formation of ordered polycyclic aromatic structures.

In some embodiments, the reducing gas contains at least some CO. A portion of the CO may undergo a Boudouard reaction to form solid carbon.

In some embodiments, the biocoking reactor is a screw coker reactor.

A coking catalyst may be added to the biocoking reactor. Alternatively, or

additionally, a hydrodeoxygenation catalyst is added to the biocoking reactor. A single catalyst may have both coking and hydrodeoxygenation catalytic functions.

In some embodiments, the biocoking reactor is operated at a biocoking temperature from about 200° C. to about 750° C. In certain embodiments, the biocoking temperature is controlled to be no greater than about 550° C.

In some embodiments, the biocoking reactor is operated at a biocoking pressure from about 100 kPa to about 1000 kPa. In certain embodiments, the biocoking pressure is from about 200 kPa to about 800 kPa.

In some embodiments, the devolatilization unit, in step (f), is operated at a devolatilization temperature from about 450° C. to about 1000° C.

In some embodiments, the devolatilization unit is operated in a substantially inert-gas atmosphere.

In some embodiments, the calcination unit, in step (g), is operated at a calcination temperature from about 1000° C. to about 1800° C. In certain embodiments, the calcination temperature is from about 1200° C. to about 1500° C.

In some embodiments, the calcination unit is operated in a substantially inert-gas atmosphere.

In some embodiments, steps (f) and (g) are combined and carried out in a single unit consisting of the devolatilization unit.

In some embodiments, the devolatilization unit, in step (f), is operated at a devolatilization temperature from about 450° C. to about 1000° C.; while in step (g), the devolatilization unit is operated at a devolatilization temperature from about 1000° C. to about 1800° C.

In some embodiments, steps (f) and (g) are conducted separately, within the devolatilization unit and the calcination unit, respectively.

In some embodiments, steps (f) and (g) are conducted at different site locations, which may physically be very far apart, or may be at adjacent facilities, for example.

In some embodiments, the weight ratio of the bioliquid feedstock to the recycled biocoke is selected from about 1 to about 10, such as from about 1 to about 4.

In some embodiments, the bioliquid feedstock includes a condensate stream obtained from condensing a vapor released from the biocoking reactor, a vapor released from the devolatilization unit, or a combined vapor from both the biocoking reactor and the devolatilization unit.

The renewable biocoke product may contain at least 80 wt % total carbon, at least 90 wt % total carbon, or at least 95 wt % total carbon, for example. In certain embodiments, the renewable biocoke product contains from about 90 wt % to about 99 wt % total carbon.

The renewable biocoke product may be at least 90% renewable, according to a measurement of the ¹⁴C/¹²C isotopic ratio of the renewable biocoke product. Preferably, the renewable biocoke product is at least 95%, at least 99%, or 100% renewable, according to a measurement of the ¹⁴C/¹²C isotopic ratio of the renewable biocoke product.

The renewable biocoke product may contain at least 50 wt % crystalline graphite according to spectroscopy (e.g., XRD). In some embodiments, the renewable biocoke product contains at least 75 wt %, or at least 90 wt %, crystalline graphite according to spectroscopy.

In various embodiments, total carbon contained in the renewable biocoke product is at least 75 wt % crystalline graphite according to spectroscopy (e.g., XRD). In some embodiments, total carbon contained in the renewable biocoke product is at least 90 wt % crystalline graphite according to spectroscopy. In certain embodiments, total carbon contained in the renewable biocoke product is at least 95 wt %, at least 96 wt %, at least 97 wt %, at least 98 wt %, or at least 99 wt % crystalline graphite according to spectroscopy.

In some embodiments, the process is operated continuously or semi-continuously. In other embodiments, the process is operated in batch.

The process may further comprise fabricating an electrode containing the renewable biocoke product. The electrode may be a metal-making electrode, such as a large electrode utilized in electric arc furnace iron (or other metal) production. The electrode may be a battery electrode. Other types of electrodes are possible, such as fuel cell electrodes, electrolysis electrodes (for making H₂ from H₂O), and other applications.

In some embodiments, steps (f) and (g) are conducted at different site locations, and the step of fabricating the electrode is conducted as the same site as step (g).

Other variations of the invention are premised on the use of a starting biocoke that is not necessarily biocoke recycled from within the process. Some embodiments provide a process for producing a renewable biocoke product from a bioliquid feedstock, the process comprising:
(a) providing a bioliquid feedstock;
(b) providing a starting biocoke;
(c) feeding the bioliquid feedstock and the starting biocoke into a biocoking reactor;
(d) feeding a reducing gas into the biocoking reactor, wherein the reducing gas contains H₂ and/or CO;
(e) within the biocoking reactor, chemically converting the bioliquid feedstock into produced biocoke by thermally cracking molecules of the bioliquid feedstock and nucleating the produced biocoke on particles of the starting biocoke as a biocoking template, wherein the reducing gas reacts with at least some oxygen present in the bioliquid feedstock to form H₂O and/or CO₂;
(f) within a devolatilization unit, devolatilizing the produced biocoke to generate a devolatilized biocoke;
(g) within a calcination unit, or within the devolatilization unit, calcining the devolatilized biocoke to generate a calcined biocoke; and
(h) recovering the calcined biocoke as a renewable biocoke product.

In some embodiments, the process further comprises recovering a portion of the produced biocoke, a portion of the devolatilized biocoke, a portion of the calcined biocoke, or a combination thereof, for use as, or as part of, the starting biocoke in step (b). Alternatively, or additionally, the starting biocoke may be obtained from a separate process that produces biocoke. Alternatively, or additionally, the starting biocoke may be purchased biocoke.

The starting biocoke may be fully renewable according to a measurement of the ¹⁴C/¹²C isotopic ratio of the starting biocoke. The renewable biocoke product may be fully renewable according to a measurement of the ¹⁴C/¹²C isotopic ratio of the renewable biocoke product.

Other variations provide a process for producing a biocoke product from a bioliquid feedstock, the process comprising:
(a) providing a bioliquid feedstock;
(b) providing a starting coke;
(c) feeding the bioliquid feedstock and the starting coke into a biocoking reactor;
(d) feeding a reducing gas into the biocoking reactor, wherein the reducing gas contains H₂ and/or CO;
(e) within the biocoking reactor, chemically converting the bioliquid feedstock into produced biocoke by thermally cracking molecules of the bioliquid feedstock and nucleating the produced biocoke on particles of the starting coke as a biocoking template, wherein the reducing gas reacts with at least some oxygen present in the bioliquid feedstock to form H₂O and/or CO₂;
(f) within a devolatilization unit, devolatilizing the produced biocoke to generate a devolatilized biocoke;
(g) within a calcination unit, or within the devolatilization unit, calcining the devolatilized biocoke to generate a calcined biocoke; and
(h) recovering the calcined biocoke as a biocoke product.

In some embodiments, the process further comprises recovering a portion of the produced biocoke, a portion of the devolatilized biocoke, a portion of the calcined biocoke, or a combination thereof, for use as, or as part of, the starting coke in step (b). Alternatively, or additionally, the starting coke may be obtained from a separate process. The starting coke may be metallurgical coke from coal. The starting coke may be petroleum coke. The starting coke may be recovered waste graphite, such as spent electrode graphite, e.g. spent lithium-ion electrode graphite.

In some embodiments, the biocoke product is at least 80% renewable according to a measurement of the ¹⁴C/¹²C isotopic ratio of the biocoke product. In preferred embodiments, the biocoke product is at least 90% renewable according to a measurement of the ¹⁴C/¹²C isotopic ratio of the biocoke product.

Some variations of the invention provide a system for producing a renewable biocoke product from a bioliquid feedstock, the system comprising:
a biocoking reactor configured to receive a bioliquid feedstock, recycled biocoke, and a reducing gas, wherein the reducing gas contains H₂ and/or CO, wherein the biocoking reactor is further configured to chemically convert the bioliquid feedstock into biocoke by thermally cracking molecules of the bioliquid feedstock and nucleating the biocoke on particles of the recycled biocoke as a biocoking template;
a devolatilization unit in flow communication with the biocoking reactor, wherein the devolatilization unit is configured to devolatilize the biocoke to generate a devolatilized biocoke;
a calcination unit in flow communication with the devolatilization unit, wherein the calcination unit is configured to calcine the devolatilized biocoke to generate a calcined biocoke;
one or more recycle lines configured to recycle a portion of the biocoke, a portion of the devolatilized biocoke, a portion of the calcined biocoke, or a combination thereof, as the recycled biocoke for use in the biocoking reactor;
a product recovery line configured to recover the calcined biocoke as a renewable biocoke product.

Exemplary systems and processes are depicted in the simplified block-flow diagrams of FIGS. 1, 2, 3, and 4.

In some systems, a separate calcination unit may be omitted when the devolatilization unit can also carry out calcining.

The system may further comprise a heated mixing unit in flow communication with the biocoking reactor, wherein the heated mixing unit is configured to pre-mix the bioliquid feedstock and the recycled biocoke.

In some systems, the biocoking reactor is a screw coker reactor.

In some systems, the devolatilization unit and the calcination unit are at different site locations.

In some preferred systems, the system is configured to operate continuously or semi-continuously.

Other variations provide a system for producing a biocoke product from a bioliquid feedstock, the system comprising:
a biocoking reactor configured to receive a bioliquid feedstock, a starting coke (which may be biocoke or another form of coke), and a reducing gas, wherein the reducing gas contains H₂ and/or CO, wherein the biocoking reactor is further configured to chemically convert the bioliquid feedstock into produced biocoke by thermally cracking molecules of the bioliquid feedstock and nucleating the produced biocoke on particles of the starting coke as a biocoking template;
a devolatilization unit in flow communication with the biocoking reactor, wherein the devolatilization unit is configured to devolatilize the produced biocoke to generate a devolatilized biocoke;
a calcination unit in flow communication with the devolatilization unit, wherein the calcination unit is configured to calcine the devolatilized biocoke to generate a calcined biocoke; and
a product recovery line configured to recover the calcined biocoke as a biocoke product.

In some embodiments, the system further comprises a heated mixing unit in flow communication with the biocoking reactor, wherein the heated mixing unit is configured to pre-mix the bioliquid feedstock and the starting coke.

The biocoking reactor may be a screw coker reactor, for example.

In some embodiments, the devolatilization unit and the calcination unit are at different site locations.

The system may be configured to operate continuously or semi-continuously.

Some variations of the invention provide a renewable biocoke product produced by a process comprising:
(a) providing a bioliquid feedstock;
(b) providing a recycled biocoke;
(c) feeding the bioliquid feedstock and the recycled biocoke into a biocoking reactor;
(d) feeding a reducing gas into the biocoking reactor, wherein the reducing gas contains H₂ and/or CO;
(e) within the biocoking reactor, chemically converting the bioliquid feedstock into biocoke by thermally cracking molecules of the bioliquid feedstock and nucleating the biocoke on particles of the recycled biocoke as a biocoking template, wherein the reducing gas reacts with at least some oxygen present in the bioliquid feedstock to form H₂O and/or CO₂;
(f) within a devolatilization unit, devolatilizing the biocoke to generate a devolatilized biocoke;
(g) within a calcination unit, or within the devolatilization unit, calcining the devolatilized biocoke to generate a calcined biocoke;
(h) recovering a portion of the biocoke, a portion of the devolatilized biocoke, a portion of the calcined biocoke, or a combination thereof, as the recycled biocoke for use in step (b); and
(i) recovering the calcined biocoke as a renewable biocoke product.

The renewable biocoke product may contain at least 80 wt % total carbon, at least 90 wt % total carbon, or at least 95 wt % total carbon. In some embodiments, the renewable biocoke product contains from about 90 wt % to about 99 wt % total carbon.

The renewable biocoke product may be at least 90%, at least 95%, at least 99%, or 100% renewable, according to a measurement of the ¹⁴C/¹²C isotopic ratio of the renewable biocoke product.

The renewable biocoke product may contain at least 50 wt %, at least 75 wt %, or at least 90 wt % crystalline graphite according to spectroscopy (e.g., XRD). These percentages are based on total weight of the renewable biocoke product, not just the carbon content.

On the basis of carbon content only, the total carbon contained in the renewable biocoke product may be at least 75 wt %, at least 90 wt %, at least 95 wt %, or at least 99 wt % crystalline graphite according to spectroscopy (e.g., XRD).

Some embodiments provide an electrode material comprising the disclosed renewable biocoke product. Some embodiments provide an electrode containing the electrode material. The electrode may be a battery electrode or a fuel cell electrode, for example. The electrode may be an electric arc furnace electrode, such as for production of iron (or another metal) or steel (or another metal alloy).

### BRIEF DESCRIPTION OF THE DRAWINGS

FIG. 1 depicts a simplified block-flow diagram of an exemplary process and system for converting a bioliquid feedstock to calcined biocoke, in some embodiments employing a biocoking reactor, a devolatilization unit, and a calcination unit.

FIG. 2 depicts a simplified block-flow diagram of an exemplary process and system for converting a bioliquid feedstock to calcined biocoke, in some embodiments employing a biocoking reactor and a combined devolatilization and a calcination unit.

FIG. 3 depicts a simplified block-flow diagram of an exemplary process and system for converting a bioliquid feedstock to calcined biocoke, in some embodiments employing a biocoking reactor, a devolatilization unit, and a calcination unit, wherein a condenser system generates a condensed bioliquid from a biomass pyrolysis vapor, and wherein the condensed bioliquid is coked in the biocoking reactor.

FIG. 4 depicts a simplified block-flow diagram of an exemplary process and system for converting a bioliquid feedstock to calcined biocoke, in some embodiments employing a biocoking reactor, a devolatilization unit, and a calcination unit, using a starting biocoke that is not necessarily a recycled biocoke.

### DETAILED DESCRIPTION OF EMBODIMENTS OF THE INVENTION

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing reaction conditions, stoichiometries, concentrations of components, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except in the case of Markush groups. Thus in some embodiments not otherwise explicitly recited, any instance of “comprising” may be replaced by “consisting of” or, alternatively, by “consisting essentially of.”

For purposes of an enabling technical disclosure, various explanations, hypotheses, theories, speculations, assumptions, and so on are disclosed. The present invention does not rely on any of these being in fact true. None of the explanations, hypotheses, theories, speculations, or assumptions in this detailed description shall be construed to limit the scope of the invention in any way.

For present purposes, “biogenic” is intended to mean a material (whether a feedstock, product, or intermediate) that contains an element, such as carbon, that is renewable on time scales of months, years, or decades. Non-biogenic materials may be non-renewable, or may be renewable on time scales of centuries, thousands of years, millions of years, or even longer geologic time scales. Note that a biogenic material may include a mixture of biogenic and non-biogenic sources.

For present purposes, “reagent” is intended to mean a material in its broadest sense; a reagent may be a fuel, a chemical, a material, a compound, an additive, a blend component, a solvent, and so on. A reagent is not necessarily a chemical reagent that causes or participates in a chemical reaction. A reagent may or may not be a chemical reactant; it may or may not be consumed in a reaction. A reagent may be a chemical catalyst for a particular reaction. A reagent may cause or participate in adjusting a mechanical, physical, or hydrodynamic property of a material to which the reagent may be added. For example, a reagent may be introduced to a metal to impart certain strength properties to the metal. A reagent may be a substance of sufficient purity (which, in the current context, is typically carbon purity) for use in chemical analysis or physical testing.

For present purposes, “renewable graphite” is a material that contains at least 50 wt % crystalline graphite according to spectroscopy, and that has 100% renewable carbon content based on a measurement of the ¹⁴C/¹²C isotopic ratio of the renewable graphite.

Needle coke is a carbonaceous material of defined, anisotropic structure. The carbon particles are shaped like needles because of the crystalline structure. Historically, needle coke has been used in the manufacture of graphite electrodes used in the steel industry's electric arc furnaces. Recent uses include the production of synthetic graphite for lithium-ion battery anode materials. Needle coke is also used to manufacture electrodes for electric double layer capacitors as an auxiliary source of power in electric vehicles.

Variations of the present invention are premised on the recognition that simple heating of bioliquid feedstocks (such as at 1400-1600° C.) will not lead to the carbon quality necessary for commercial applications such as Li-ion batteries, or anodes for iron smelting. Conventional production of needle coke uses decanted heavy oil from a fluidized catalytic cracking unit in a petroleum refinery. Decanted heavy oil has a molecular structure that enables efficient conversion to needle coke. Bioliquid feedstocks, on the other hand, contain lignin polymers and other oxygen-containing polymers, which are much more difficult to convert to needle coke or other renewable biocoke products.

In some variations, the invention provides a process for producing a renewable biocoke product from a bioliquid feedstock, the process comprising:
(a) providing a bioliquid feedstock;
(b) providing a recycled biocoke;
(c) feeding the bioliquid feedstock and the recycled biocoke into a biocoking reactor;
(d) feeding a reducing gas into the biocoking reactor, wherein the reducing gas contains H₂ and/or CO;
(c) within the biocoking reactor, chemically converting the bioliquid feedstock into biocoke by thermally cracking molecules of the bioliquid feedstock and nucleating the biocoke on particles of the recycled biocoke as a biocoking template, wherein the reducing gas reacts with at least some oxygen present in the bioliquid feedstock to form H₂O and/or CO₂;
(f) within a devolatilization unit, devolatilizing the biocoke to generate a devolatilized biocoke;
(g) within a calcination unit, or within the devolatilization unit, calcining the devolatilized biocoke to generate a calcined biocoke;
(h) recovering a portion of the biocoke, a portion of the devolatilized biocoke, a portion of the calcined biocoke, or a combination thereof, as the recycled biocoke for use in step (b); and (i) recovering the calcined biocoke as a renewable biocoke product.

A “bioliquid feedstock” means a liquid-phase feed material that is derived from biomass. The bioliquid feedstock contains fully renewable carbon according to a measurement of the ¹⁴C/¹²C isotopic ratio of the bioliquid feedstock.

In some embodiments, the bioliquid feedstock is obtained from condensing and optionally fractionating a pyrolysis vapor from biomass pyrolysis. Condensing the pyrolysis vapor is performed using a condenser system, which may employ a single-stage condenser or a multiple-stage condenser. When fractionation is employed, the fractionation may be applied to the pyrolysis vapor, the condensed liquid, or both of these. Fractionation may separate according to molecular weight, boiling point, polarity, water content, or a combination thereof.

In some embodiments, the condenser system is a thermally controlled multiple-stage separation system configured to capture multiple liquid fractions. The multiple liquid fractions may be separated according to molecular weight, boiling point, polarity, water content, or a combination thereof, for example. The condensate may include at least two of the multiple liquid fractions in recombined form. In certain embodiments, at least one of the multiple liquid fractions is recovered as a light co-product that does not form part of the condensate.

In some embodiments, the bioliquid feedstock includes a condensate stream obtained from condensing a vapor released from the biocoking reactor, a vapor released from the devolatilization unit, or a combined vapor from both the biocoking reactor and the devolatilization unit.

In some embodiments, the bioliquid feedstock is an external feedstock from a variety of sources. The bioliquid feedstock may be obtained from an adjacent biorefinery, or may be obtained commercially and transported to the process site. The bioliquid feedstock may be a crude bioliquid or a purified bioliquid. The bioliquid feedstock may contain lignin, lignin derivatives, sugars, sugar derivatives, and sugar degradation products (e.g., furfural), for example. In preferred embodiments, the bioliquid feedstock contains aromatic groups, since aromatics are typically more carbon-rich than olefins, alkanes, alcohols, and organic acids. In some embodiments, the bioliquid feedstock contains polyphenols.

When the bioliquid feedstock is obtained from an external source, the external source may be a site that carries out any of the processes disclosed herein. The external source may be a commercial chemical company. The external source may be a biorefinery that produces a lignin or lignin-derived co-product. The lignin may be obtained from a biorefinery plant that uses pyrolysis, gasification, acid hydrolysis, enzymatic hydrolysis, chemical pulping, mechanical pulping, thermochemical pulping, or other process. Another external source of a bioliquid feedstock may be a food or nutraceutical manufacturing plant, such as one processing blueberries, plums, cherries, apples, strawberries, black currants, black olives, dark chocolate, black tea, coffee, hazelnuts, or pecans, all of which are relatively rich in polyphenols. Another external source of a polyphenolic material may be a natural-dye manufacturing plant.

The bioliquid feedstock may contain, on a dry basis, from about 20 wt % to about 90 wt %, such as from about 30 wt % to about 75 wt %, or from about 40 wt % to about 60 wt % carbon. The bioliquid feedstock may be water-free or may contain water in a concentration from about 0.1 wt % to about 50 wt %, such as from about 1 wt % to about 20 wt % water, for example.

The bioliquid feedstock and the recycled biocoke may be mixed in a mixing unit, or may be co-fed directly into the biocoking reactor. Various types of mixing units may be employed, such as container mixers, static mixers, dynamic mixers, agitated tanks, or homogenizers.

In some embodiments, the bioliquid feedstock and the recycled biocoke are pre-mixed in a heated mixing unit prior to feeding to the biocoking reactor. When a heated mixing unit is employed, the temperature of the mixing unit may be selected from about 50° C. to about 200° C., such as from about 75° C. to about 150° C., for example.

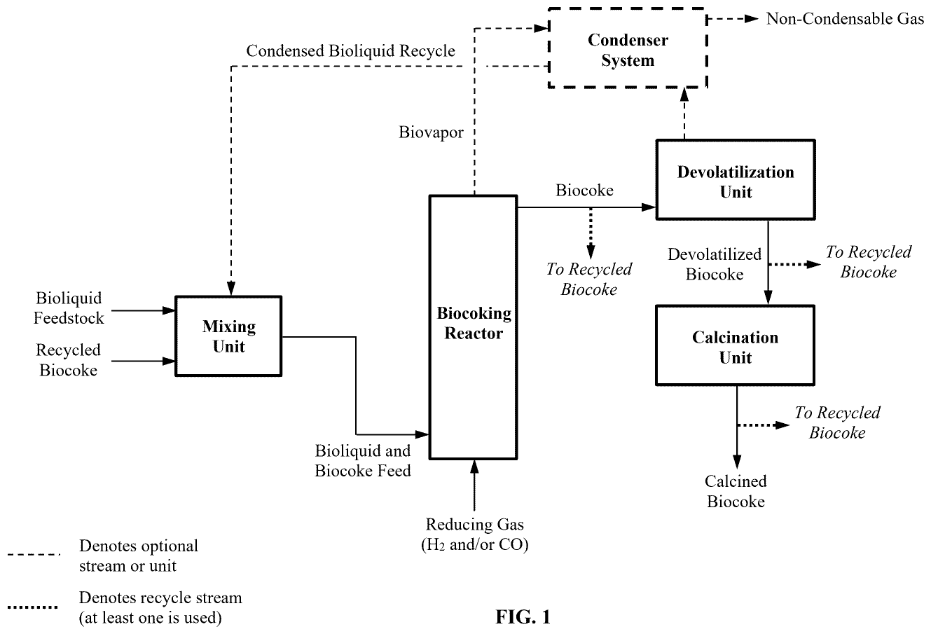

In the diagrams of FIGS. 1-4, the reducing gas is fed directly into the biocoking reactor. However, the feed of reducing gas is not necessarily injected directly into the biocoking reactor. In some embodiments, some or all of the reducing gas is injected into a stream of the mixed bioliquid feedstock and recycled biocoke, such as to carry the mixed stream into the biocoking reactor, or to begin to heat up the mixed stream, for example. In certain embodiments, some or all of the reduced gas is fed into the mixing unit, such as to enhance mixing or heating within the mixing unit.

In some embodiments, the reducing gas is obtained from collecting and optionally fractionating and/or treating a non-condensable gas stream from biomass pyrolysis. For instance, when the non-condensable gas stream contains H₂, that hydrogen may be separated out and used as a reducing gas. Water-gas shift chemistry may be applied to the non-condensable gas stream to adjust the H₂/CO ratio in the reducing gas, for example.

In some embodiments, the reducing gas contains at least some H₂. The H₂ may cause hydrodeoxygenation of oxygen-containing molecules of the bioliquid feedstock, removing oxygen to generate carbon-rich molecules along with H₂O. A portion of the H₂ may react with organics within the bioliquid feedstock or within the biocoke. The reaction of the H₂ with the organics may assist formation of ordered polycyclic aromatic structures, enhancing the final yield and/or quality of the calcined biocoke product.

In some embodiments, the reducing gas contains at least some CO. The CO may cause deoxygenation of oxygen-containing molecules of the bioliquid feedstock, removing oxygen to generate carbon-rich molecules along with CO₂. A portion of the CO may undergo a Boudouard reaction to form solid carbon. That solid carbon may be deposited on the particles of recycled biocoke or become part of the newly formed graphene-like layers from the reaction of bioliquid molecules, as additional carbon in the calcined biocoke product.

Various types of biocoking reactors may be employed, including batch reactors (e.g., coke drums) and continuous reactors (e.g., screw-type reactors). In some embodiments, the biocoking reactor uses the principles of a delayed coker, a fluidized coker, or a flexicoker. In certain embodiments, the biocoking reactor is a screw coker reactor, which is a continuous or semi-continuous reactor utilizing a screw or auger to convey the biocoke through the reaction zone.

In the biocoking reactor, the bioliquid feedstock is thermally cracked, which means that the feedstock molecules undergo bond breakage and molecular rearrangement to form biocoke. The kinetics of the bond breakage and molecular rearrangement are enhanced by the elevated temperature in the biocoking reactor. “Thermal cracking” does not preclude catalytic cracking, if a catalyst is present or catalysis occurs via the recycled coke particles themselves.

A coking catalyst may be added to the biocoking reactor. Alternatively, or additionally, a hydrodeoxygenation catalyst may be added to the biocoking reactor. A single catalyst may have both coking and hydrodeoxygenation catalytic functions. Examples of coking catalysts include zeolites, metal-based catalysts, metal oxide-based catalysts, and inorganic salts. Examples of hydrodeoxygenation catalysts include sulfided nickel-molybdenum or sulfided cobalt-molybdenum, typically on a catalyst support such as alumina. If a coking or hydrodeoxygenation catalyst is added to the biocoking reactor, the catalyst may remain in the final calcined biocoke, which may be acceptable due to low concentrations of catalyst.

In some embodiments, the biocoking reactor is operated at a biocoking temperature from about 200° C. to about 750° C. In certain embodiments, the biocoking temperature is controlled to be no greater than about 550° C. In various embodiments, the biocoking temperature is about, at least about, or at most about 250° C., 300° C., 350° C., 400° C., 450° C., 500° C., 550° C., 600° C., 650° C., 700° C., or 750° C., including any intervening range.

In some embodiments, the biocoking reactor is operated at a biocoking pressure from about 100 kPa to about 1000 kPa. In certain embodiments, the biocoking pressure is from about 200 kPa to about 800 kPa. In various embodiments, the biocoking pressure is about, at least about, or at most about 100, 200, 300, 400, 500, 600, 700, 800, 900, or 1000 kPa, including any intervening range.

In some embodiments, the biocoking reactor is operated at a biocoking solid-phase residence time selected from about 30 minutes to about 24 hours, such as from about 4 hours to about 20 hours. In various embodiments, the biocoking solid-phase residence time is about, at least about, or at most about 0.5, 1, 2, 3, 4, 5, 6, 7, 8, 9, 10, 11, 12, 13, 14, 15, 16, 17, 18, 19, 20, 21, 22, 23, or 24 hours, including any intervening range.

In some embodiments, the biocoking reactor is operated at a biocoking vapor-phase residence time selected from about 5 minutes to about 8 hours, such as from about 15 minutes to about 4 hours. In various embodiments, the biocoking vapor-phase residence time is about, at least about, or at most about 0.1, 0.2, 0.3, 0.4, 0.5, 1, 2, 3, 4, 5, 6, 7, or 8 hours, including any intervening range.

The flow pattern of the biocoking reactor may be plug flow, well-mixed flow (e.g., in a fluidized bed), or an intermediate flow pattern between these two extremes. The reducing gas may flow co-current, countercurrent, or cross-current relative to the flow of solids (and, if present, liquids).

In some embodiments, the devolatilization unit, in step (f), is operated at a devolatilization temperature from about 450° C. to about 1000° C. In various embodiments, the devolatilization temperature is about, at least about, or at most about 500° C., 550° C., 600° C., 650° C., 700° C., 750° C., 800° C., 850° C., 900° C., 950° C., or 1000° C., including any intervening range.

In some embodiments, the devolatilization unit is operated in a substantially inert-gas atmosphere. A substantially inert-gas atmosphere for the devolatilization unit may be achieved using nitrogen or argon, for example.

In some embodiments, the calcination unit, in step (g), is operated at a calcination temperature from about 1000° C. to about 1800° C. In certain embodiments, the calcination temperature is from about 1200° C. to about 1500° C. In various embodiments, the calcination temperature is about, at least about, or at most about 1000° C., 1100° C., 1200° C., 1300° C., 1400° C., 1500° C., 1600° C., 1700° C., or 1800° C., including any intervening range.

In some embodiments, the calcination unit is operated in a substantially inert-gas atmosphere. A substantially inert-gas atmosphere for the calcination unit may be achieved using nitrogen or argon, for example.

In some embodiments, steps (f) and (g) are combined and carried out in a single unit consisting of the devolatilization unit. In these embodiments, the devolatilization unit may also be referred to as a combined devolatilization and calcination unit, a devolatilization-calcination unit, or the like.

In some embodiments, the devolatilization unit, in step (f), is operated at a devolatilization temperature from about 450° C. to about 1000° C.; while in step (g), the devolatilization unit is operated at a devolatilization temperature from about 1000° C. to about 1800° C.

In typical embodiments, steps (f) and (g) are conducted separately, within a devolatilization unit and a calcination unit, respectively. Steps (f) and (g) may be conducted at different site locations, which may physically be very far apart, or may be at adjacent facilities, for example.

In some embodiments, the weight ratio of the bioliquid feedstock to the recycled biocoke is selected from about 1 to about 10, such as from about 1 to about 4. In various embodiments, the weight ratio of the bioliquid feedstock to the recycled biocoke is about, at least about, or at most about 0.1, 0.2, 0.3, 0.4, 0.5, 0.6, 0.7, 0.8, 0.9, 1, 1.5, 2, 2.5, 3, 3.5, 4, 5, 6, 7, 8, 9, or 10, including any intervening range.

Various fractions of the biocoke (made in the biocoking reactor), the devolatilized biocoke, and the calcined biocoke, may be recycled to the mixing unit. In some embodiments, some biocoke is recycled, and no devolatilized biocoke or calcined biocoke are recycled. In some embodiments, some devolatilized biocoke is recycled, and no biocoke or calcined biocoke are recycled. In some embodiments, some calcined biocoke is recycled, and no biocoke or devolatilized biocoke are recycled. In some embodiments, some biocoke and some devolatilized biocoke are recycled, and no calcined biocoke is recycled. In some embodiments, some biocoke and some calcined biocoke are recycled, and no devolatilized biocoke is recycled. In some embodiments, some devolatilized biocoke and some calcined biocoke are recycled, and no biocoke is recycled. In certain embodiments, none of the biocoke, devolatilized biocoke, calcined biocoke are recycled; rather, the recycled biocoke comprises an external source of recycled, reused, or waste biocoke.

The recycle ratio of biocoke (made in the biocoking reactor) can be designated as R₁, defined as the mass flow rate of the biocoke recycle that is recycled to the mixing unit, divided by the total mass flow rate of the biocoke stream following optional separation of biovapor). The total mass flow rate of the biocoke stream equals the mass flow rate recycled plus the mass flow rate feeding into the devolatilization unit.

The recycle ratio of devolatilized biocoke can be designated as R₂, defined as the mass flow rate of the devolatilized biocoke that is recycled to the mixing unit, divided by the total mass flow rate of the devolatilized biocoke. The total mass flow rate of the devolatilized biocoke equals the mass flow rate recycled plus the mass flow rate feeding into the calcination unit.

The recycle ratio of calcined biocoke can be designated as R₃, defined as the mass flow rate of the calcined biocoke that is recycled to the mixing unit, divided by the total mass flow rate of the calcined biocoke. The total mass flow rate of the calcined biocoke equals the mass flow rate recycled plus the mass flow rate of the calcined biocoke product.

In some embodiments, R₁ is selected from 0 to 0.9, such as about, at least about, or at most about 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9, including any intervening range.

In some embodiments, R₂ is selected from 0 to 0.9, such as about, at least about, or at most about 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9, including any intervening range.

In some embodiments, R₃ is selected from 0 to 0.9, such as about, at least about, or at most about 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9, including any intervening range.

In some embodiments, the sum (R₁+R₂) is selected from 0 to 0.9, such as about, at least about, or at most about 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9, including any intervening range.

In some embodiments, the sum (R₁+R₃) is selected from 0 to 0.9, such as about, at least about, or at most about 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9, including any intervening range.

In some embodiments, the sum (R₂+R₃) is selected from 0 to 0.9, such as about, at least about, or at most about 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9, including any intervening range.

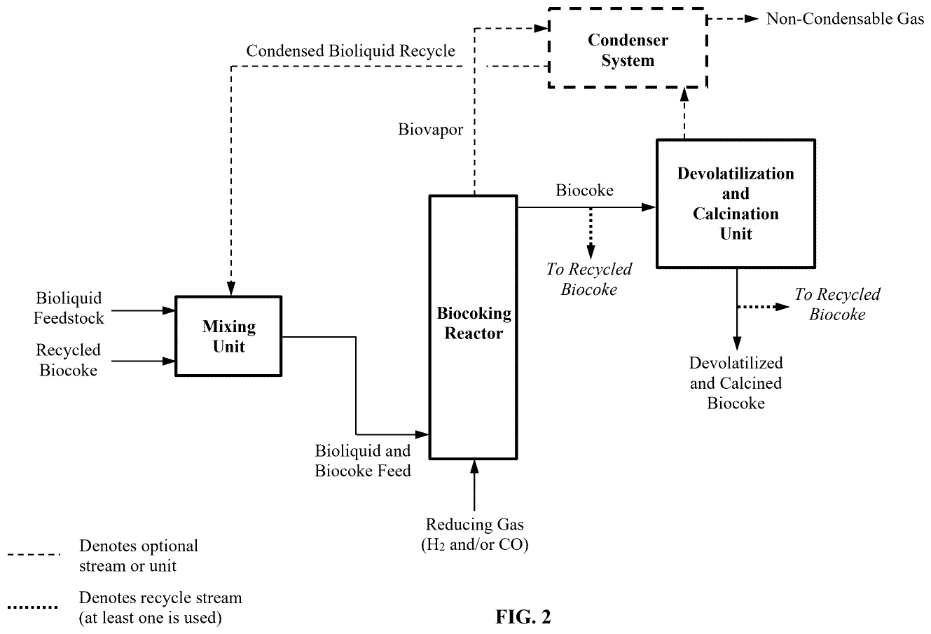

In FIG. 2, a combined devolatilization and calcination unit is employed. In those embodiments, the recycle ratio of devolatilized and calcined biocoke can be designated as R_{2,3}, defined as the mass flow rate of the devolatilized and calcined biocoke that is recycled to the mixing unit, divided by the total mass flow rate of the devolatilized and calcined biocoke. The total mass flow rate of the devolatilized and calcined biocoke equals the mass flow rate recycled plus the mass flow rate of the devolatilized and calcined biocoke product. In some embodiments, R_{2,3} is selected from 0 to 0.9, such as about, at least about, or at most about 0, 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9, including any intervening range.

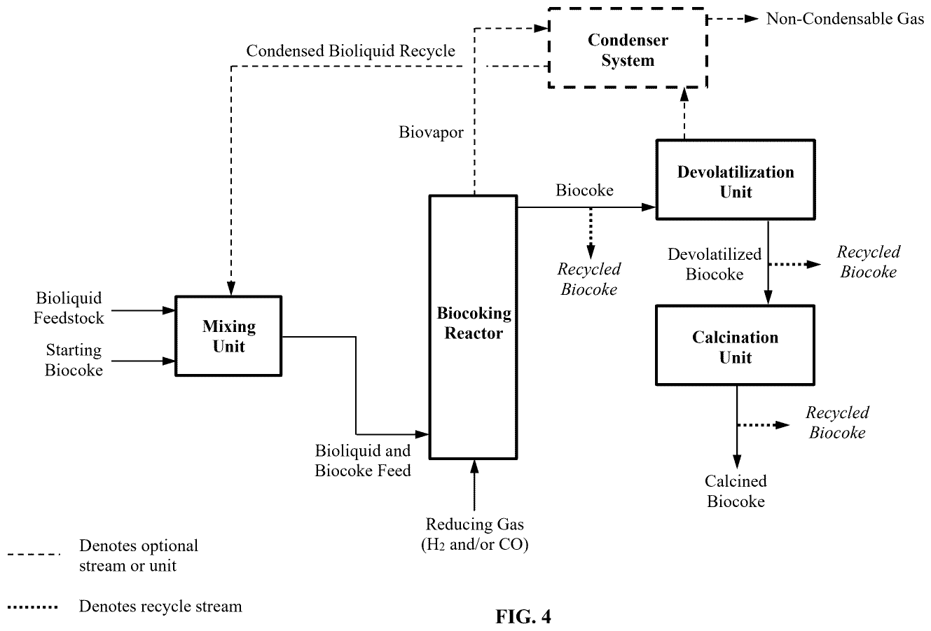

In some embodiments relating to FIG. 1, 3, or 4, the sum (R₁+R₂+R₃) is selected from 0 to 0.9, such as about, at least about, or at most about 0, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95, including any intervening range. When at least some of the starting biocoke is recycled in situ biocoke, then (R₁+R₂+R₃)>0. When the starting biocoke (or generally, starting coke) contains no recycled biocoke, then (R₁+R₂+R₃)=0 (see FIG. 4).

In some embodiments relating to FIG. 2, the sum (R₁+R_{2,3}) is selected from 0 to 0.9, such as about, at least about, or at most about 0, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95, including any intervening range. When at least some of the recycled biocoke is in situ biocoke, then (R₁+R_{2,3})>0.

Preferably, at least some of the recycled biocoke is in situ biocoke, which means it is one or more of the biocoke (made in the biocoking reactor), the devolatilized biocoke, or the calcined biocoke, made in an integrated process and system. Of the recycled biocoke, the mass percentage of the recycled biocoke in in situ biocoke may be about, or at least about, 0, 5%, 10%, 15%, 20%, 25%, 30%, 40%, 50%, 60%, 70%, 80%, 90%, 95%, or 100%, including any intervening range.

When the desired product is graphite, the graphite material quality is typically determined according to carbon purity and lattice (crystalline) characteristics. The renewable biocoke product may contain at least 80 wt % total carbon, at least 90 wt % total carbon, or at least 95 wt % total carbon, for example. In certain embodiments, the renewable biocoke product contains from about 90 wt % to about 99 wt % total carbon.

The renewable biocoke product may contain at least 50 wt % crystalline graphite according to spectroscopy. In some embodiments, the renewable biocoke product contains at least 75 wt %, or at least 90 wt %, crystalline graphite according to spectroscopy. In various embodiments, the renewable biocoke product contains about, or at least about, 50, 55, 60, 65, 70, 75, 80, 85, 90, or 95 wt % crystalline graphite according to spectroscopy.

In some embodiments, total carbon contained in the renewable biocoke product is at least 75 wt % crystalline graphite according to spectroscopy. In certain embodiments, the total carbon contained in the renewable biocoke product is at least 90 wt %, at least 95 wt %, at least 96 wt %, at least 97 wt %, at least 98 wt %, or at least 99 wt % crystalline graphite according to spectroscopy. In various embodiments, the total carbon contained in the renewable biocoke product is about, or at least about, 75, 80, 85, 90, 95, or 99 wt % crystalline graphite according to spectroscopy.

In this specification, “spectroscopy” refers to the measurement of spectra produced when matter (in this case, a sample of renewable biocoke product) interacts with or emits electromagnetic radiation. As is known in the graphite art, there are several spectroscopic methods that may be used to determine crystallinity of carbon. In some embodiments, crystalline graphite is determined according to X-ray diffraction (XRD). In some embodiments, crystalline graphite is determined according to Raman spectroscopy, utilizing inelastic (Raman) scattering of photons. In some embodiments, crystalline graphite is determined according to combined XRD-Raman spectroscopy. It is also possible to use thermal methods (e.g., thermogravimetric analysis) to estimate the crystallinity of carbon. Thermal methods may be used in conjunction with spectroscopy, or may be used alone, such as with a prior calibration of crystalline graphite content according to spectroscopy or against known graphite standards.

The renewable biocoke product may be at least 90% renewable, according to a measurement of the ¹⁴C/¹²C isotopic ratio of the renewable biocoke product. Preferably, the renewable biocoke product is at least 95%, at least 99%, or 100% (fully) renewable, according to a measurement of the ¹⁴C/¹²C isotopic ratio of the renewable biocoke product.

In preferred embodiments, the process is operated continuously or semi-continuously. In other embodiments, the process is operated in batch.

The process may further comprise fabricating an electrode containing the renewable biocoke product. The electrode may be a metal-making electrode, such as a large electrode utilized in electric arc furnace iron or steel production. The electrode may be a battery electrode. Other types of electrodes are possible, such as fuel cell electrodes or electrolysis electrodes, among many other electrode applications. In some embodiments, steps (f) and (g) are conducted at different site locations, and the step of fabricating the electrode is conducted as the same site as step (g).

The process may further comprise fabricating an object, other than an electrode, from the renewable biocoke product. The object may be a structural object (e.g., an engineered element), since graphite has good mechanical properties for some applications. The object may be a pellet, such as for metal-making (e.g., to replace metallurgical coke). The object may be formed for coke replacement in any commercial application of traditional coke or petroleum coke.

Other variations of the invention are premised on the use of a starting biocoke that is not necessarily biocoke recycled from within the process. Some embodiments provide a process for producing a renewable biocoke product from a bioliquid feedstock, the process comprising:
(a) providing a bioliquid feedstock;
(b) providing a starting biocoke;
(c) feeding the bioliquid feedstock and the starting biocoke into a biocoking reactor;
(d) feeding a reducing gas into the biocoking reactor, wherein the reducing gas contains H₂ and/or CO;
(e) within the biocoking reactor, chemically converting the bioliquid feedstock into produced biocoke by thermally cracking molecules of the bioliquid feedstock and nucleating the produced biocoke on particles of the starting biocoke as a biocoking template, wherein the reducing gas reacts with at least some oxygen present in the bioliquid feedstock to form H₂O and/or CO₂;
(f) within a devolatilization unit, devolatilizing the produced biocoke to generate a devolatilized biocoke;
(g) within a calcination unit, or within the devolatilization unit, calcining the devolatilized biocoke to generate a calcined biocoke; and
(h) recovering the calcined biocoke as a renewable biocoke product.

In some embodiments, the process further comprises recovering a portion of the produced biocoke, a portion of the devolatilized biocoke, a portion of the calcined biocoke, or a combination thereof, for use as, or as part of, the starting biocoke in step (b).

Alternatively, or additionally, the starting biocoke may be obtained from a separate process that produces biocoke. A separate process that produces biocoke may be any type of biomass pyrolysis process that generates biocarbon, such as (but not limited to) biomass pyrolysis processes disclosed herein. A separate process that produces biocoke may start with vapor feedstocks, such as methane (e.g., renewable natural gas from anerobic digestion) or carbon dioxide (e.g., CO₂ co-product from sugar fermentation to ethanol).

Alternatively, or additionally, the starting biocoke may be purchased biocoke. Purchased biocoke may indicate the coke is bio-derived or renewable, but may not necessarily indicate the exact process or starting feedstock(s).

The starting biocoke may be fully renewable according to a measurement of the ¹⁴C/¹²C isotopic ratio of the starting biocoke. When the starting biocoke is fully renewable, then the renewable biocoke product is potentially fully renewable according to a measurement of the ¹⁴C/¹²C isotopic ratio of the renewable biocoke product-provided that the bioliquid is fully renewable according to a measurement of the ¹⁴C/¹²C isotopic ratio of the bioliquid.

Other variations of the invention are premised on the use of a starting coke that is not necessarily biocoke. Some embodiments provide a process for producing a biocoke product from a bioliquid feedstock, the process comprising:
(a) providing a bioliquid feedstock;
(b) providing a starting coke;
(c) feeding the bioliquid feedstock and the starting coke into a biocoking reactor;
(d) feeding a reducing gas into the biocoking reactor, wherein the reducing gas contains H₂ and/or CO;
(e) within the biocoking reactor, chemically converting the bioliquid feedstock into produced biocoke by thermally cracking molecules of the bioliquid feedstock and nucleating the produced biocoke on particles of the starting coke as a biocoking template, wherein the reducing gas reacts with at least some oxygen present in the bioliquid feedstock to form H₂O and/or CO₂;
(f) within a devolatilization unit, devolatilizing the produced biocoke to generate a devolatilized biocoke;
(g) within a calcination unit, or within the devolatilization unit, calcining the devolatilized biocoke to generate a calcined biocoke; and
(h) recovering the calcined biocoke as a biocoke product.

In some embodiments, the process further comprises recovering a portion of the produced biocoke, a portion of the devolatilized biocoke, a portion of the calcined biocoke, or a combination thereof, for use as, or as part of, the starting coke in step (b).

Alternatively, or additionally, the starting coke may be obtained from a separate process. The starting coke may be metallurgical coke from coal. The starting coke may be petroleum coke. The starting coke may be, or be derived from, conventional carbon black. The starting coke may be made from natural gas, via methane pyrolysis. The starting coke may be made from atmospheric CO₂, such as via electrochemical conversion. Note that much of the ˜430 ppm CO₂ in the atmosphere is derived from fossil carbon, but coke made from atmospheric CO₂ may still considered to be renewable-much like CO₂ taken up by plants during photosynthesis is considered renewable.

The starting coke may be recovered waste graphite, such as spent electrode graphite, e.g. spent lithium-ion electrode graphite. Although the original graphite may be e.g. mined graphite and not renewable, using a waste material that otherwise would be destined for a landfill has environmental and economic benefits, and may qualify for certain green credits.

In some embodiments, the biocoke product is at least 80% renewable according to a measurement of the ¹⁴C/¹²C isotopic ratio of the biocoke product. In preferred embodiments, the biocoke product is at least 90% renewable according to a measurement of the ¹⁴C/¹²C isotopic ratio of the biocoke product. In various embodiments, the biocoke product is at least 80%, 81%, 82%, 83%, 84%, 85%, 86%, 87%, 88%, 89%, 90%, 91%, 92%, 93%, 94%, or 95% renewable according to a measurement of the ¹⁴C/¹²C isotopic ratio of the biocoke product.

Some processes are premised on the recognition that for certain applications not requiring high-quality graphite, the devolatilized biocoke need not be calcined. Some variations provide a process for producing a renewable biocoke product from a bioliquid feedstock, the process comprising:
(a) providing a bioliquid feedstock;
(b) providing a recycled biocoke;
(c) feeding the bioliquid feedstock and the recycled biocoke into a biocoking reactor;
(d) feeding a reducing gas into the biocoking reactor, wherein the reducing gas contains H₂ and/or CO;
(e) within the biocoking reactor, chemically converting the bioliquid feedstock into biocoke by thermally cracking molecules of the bioliquid feedstock and nucleating the biocoke on particles of the recycled biocoke as a biocoking template, wherein the reducing gas reacts with at least some oxygen present in the bioliquid feedstock to form H₂O and/or CO₂;
(f) within a devolatilization unit, devolatilizing the biocoke to generate a devolatilized biocoke;
(g) recovering a portion of the biocoke, a portion of the devolatilized biocoke, or a combination thereof, as the recycled biocoke for use in step (b); and
(h) recovering the devolatilized biocoke as a renewable biocoke product.

Some variations of the invention provide a system for producing a renewable biocoke product from a bioliquid feedstock, the system comprising:
a biocoking reactor configured to receive a bioliquid feedstock, recycled biocoke, and a reducing gas, wherein the reducing gas contains H₂ and/or CO, wherein the biocoking reactor is further configured to chemically convert the bioliquid feedstock into biocoke by thermally cracking molecules of the bioliquid feedstock and nucleating the biocoke on particles of the recycled biocoke as a biocoking template;
a devolatilization unit in flow communication with the biocoking reactor, wherein the devolatilization unit is configured to devolatilize the biocoke to generate a devolatilized biocoke;
a calcination unit in flow communication with the devolatilization unit, wherein the calcination unit is configured to calcine the devolatilized biocoke to generate a calcined biocoke;
one or more recycle lines configured to recycle a portion of the biocoke, a portion of the devolatilized biocoke, a portion of the calcined biocoke, or a combination thereof, as the recycled biocoke for use in the biocoking reactor;
a product recovery line configured to recover the calcined biocoke as a renewable biocoke product.

In some systems, a separate calcination unit may be omitted when the devolatilization unit can also carry out calcining.

The system may further comprise a heated mixing unit in flow communication with the biocoking reactor, wherein the heated mixing unit is configured to pre-mix the bioliquid feedstock and the recycled biocoke.

In some systems, the biocoking reactor is a screw coker reactor. Various types of biocoking reactors may be employed, including batch reactors (e.g., coke drums) and continuous reactors (e.g., screw-type reactors). In some embodiments, the biocoking reactor uses the principles of a delayed coker, a fluidized coker, or a flexicoker.

In some systems, the devolatilization unit and the calcination unit are at different site locations. The system site may be the site of existing graphite production. The system site may be the site of existing electrode production. The system site may be the site of existing bioliquid production or co-production. The system site may be a greenfield or brownfield site.

In some preferred systems, the system is configured to operate continuously or semi-continuously.

Other variations provide a system for producing a biocoke product from a bioliquid feedstock, the system comprising:
a biocoking reactor configured to receive a bioliquid feedstock, a starting coke (which may be biocoke or another form of coke), and a reducing gas, wherein the reducing gas contains H₂ and/or CO, wherein the biocoking reactor is further configured to chemically convert the bioliquid feedstock into produced biocoke by thermally cracking molecules of the bioliquid feedstock and nucleating the produced biocoke on particles of the starting coke as a biocoking template;
a devolatilization unit in flow communication with the biocoking reactor, wherein the devolatilization unit is configured to devolatilize the produced biocoke to generate a devolatilized biocoke;
a calcination unit in flow communication with the devolatilization unit, wherein the calcination unit is configured to calcine the devolatilized biocoke to generate a calcined biocoke;
and a product recovery line configured to recover the calcined biocoke as a biocoke product.

In some embodiments, the system further comprises a heated mixing unit in flow communication with the biocoking reactor, wherein the heated mixing unit is configured to pre-mix the bioliquid feedstock and the starting coke.

The biocoking reactor may be a screw coker reactor, for example.

In some embodiments, the devolatilization unit and the calcination unit are at different site locations.

The system may be configured to operate continuously or semi-continuously.

The drawings of FIGS. 1, 2, 3, and 4 show simplified block-flow diagrams of processes and systems for production of renewable biocoke from a bioliquid feedstock.

In FIG. 1, a bioliquid feedstock (e.g., condensed pyrolysis vapor) and recycled biocoke are introduced to a mixing unit. The combined bioliquid and biocoke are fed to a biocoking reactor. The biocoking reactor is also fed a reducing gas (H₂ and/or CO). In the biocoking reactor, the bioliquid feedstock is thermally cracked, and biocoke is nucleated on particles of the recycled biocoke, functioning as a biocoking template. The reducing gas reacts with oxygen present in the bioliquid feedstock, thereby removing oxygen. The output of the biocoking reactor is biocoke and biovapor. The biocoke is conveyed to a devolatilization unit, to generate devolatilized biocoke. The devolatilized biocoke is conveyed to a calcination unit, to generate calcined biocoke. The calcined biocoke is recovered as a renewable biocoke product. Optionally, a portion of the biocoke made in the biocoking reactor is recycled to the mixing unit. Optionally, a portion of the devolatilized biocoke is recycled to the mixing unit. Optionally, a portion of the calcined biocoke is recycled to the mixing unit. It is also possible for the recycled biocoke, fed to the mixing unit, to be recycled from another process and thus not be obtained from any of the biocoke, devolatilized biocoke, or calcined biocoke. The biovapor may be sent to a condenser system, generating condensed bioliquid and non-condensable gas. Optionally, the condensed bioliquid may be recycled to the mixing unit.

In FIG. 2, a bioliquid feedstock (e.g., condensed pyrolysis vapor) and recycled biocoke are introduced to a mixing unit. The combined bioliquid and biocoke are fed to a biocoking reactor. The biocoking reactor is also fed a reducing gas (H₂ and/or CO). In the biocoking reactor, the bioliquid feedstock is thermally cracked, and biocoke is nucleated on particles of the recycled biocoke, functioning as a biocoking template. The reducing gas reacts with oxygen present in the bioliquid feedstock, thereby removing oxygen. The output of the biocoking reactor is biocoke and a biovapor. The biocoke is conveyed to a combined devolatilization and calcination unit, to generate devolatilized and calcined biocoke. The devolatilized and calcined biocoke is recovered as a renewable biocoke product. Optionally, a portion of the biocoke made in the biocoking reactor is recycled to the mixing unit. Optionally, a portion of the devolatilized and calcined biocoke is recycled to the mixing unit. It is also possible for the recycled biocoke, fed to the mixing unit, to be recycled from another process and thus not be obtained from either of the biocoke or the devolatilized and calcined biocoke. The biovapor may be sent to a condenser system, generating a condensed bioliquid and a non-condensable gas. Optionally, the condensed bioliquid may be recycled to the mixing unit.

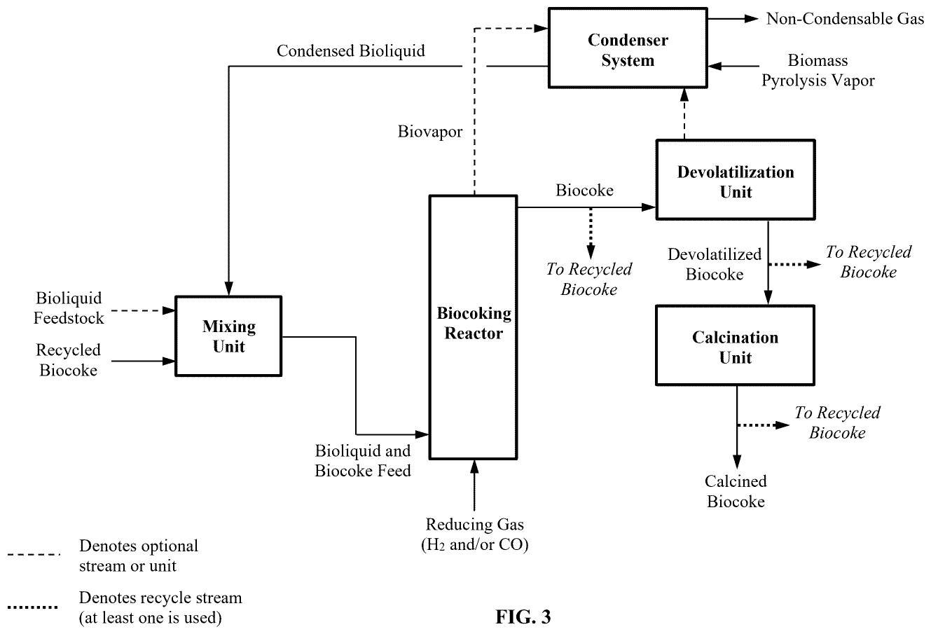

In FIG. 3, a bioliquid feedstock (e.g., condensed pyrolysis vapor) and recycled biocoke are introduced to a mixing unit. The combined bioliquid and biocoke are fed to a biocoking reactor. The biocoking reactor is also fed a reducing gas (H₂ and/or CO). In the biocoking reactor, the bioliquid feedstock is thermally cracked, and biocoke is nucleated on particles of the recycled biocoke, functioning as a biocoking template. The reducing gas reacts with oxygen present in the bioliquid feedstock, thereby removing oxygen. The output of the biocoking reactor is biocoke and a biovapor. The biocoke is conveyed to a devolatilization unit, to generate devolatilized biocoke. The devolatilized biocoke is conveyed to a calcination unit, to generate calcined biocoke. The calcined biocoke is recovered as a renewable biocoke product. Optionally, a portion of the biocoke made in the biocoking reactor is recycled to the mixing unit. Optionally, a portion of the devolatilized biocoke is recycled to the mixing unit. Optionally, a portion of the calcined biocoke is recycled to the mixing unit. It is also possible for the recycled biocoke, fed to the mixing unit, to be recycled from another process and thus not be obtained from any of the biocoke, devolatilized biocoke, or calcined biocoke. A condenser system is configured to receive a biomass pyrolysis vapor and condense at least a portion of that vapor, to generate a condensed bioliquid and a non-condensable gas. Optionally, the biovapor from the biocoking reactor is also conveyed to the condenser system.

FIG. 4 depicts a simplified block-flow diagram of an exemplary process and system for converting a bioliquid feedstock to calcined biocoke, in some embodiments employing a biocoking reactor, a devolatilization unit, and a calcination unit, using a starting biocoke that is not necessarily a recycled biocoke. In FIG. 4, a bioliquid feedstock (e.g., condensed pyrolysis vapor) and a starting biocoke are introduced to a mixing unit. The combined bioliquid and biocoke are fed to a biocoking reactor. The biocoking reactor is also fed a reducing gas (H₂ and/or CO). In the biocoking reactor, the bioliquid feedstock is thermally cracked, and new biocoke is nucleated on particles of the starting biocoke, functioning as a biocoking template. The reducing gas reacts with oxygen present in the bioliquid feedstock, thereby removing oxygen. The output of the biocoking reactor is biocoke and biovapor. The biocoke is conveyed to a devolatilization unit, to generate devolatilized biocoke. The devolatilized biocoke is conveyed to a calcination unit, to generate calcined biocoke. The calcined biocoke is recovered as a renewable biocoke product. Optionally, a portion of the biocoke made in the biocoking reactor is recycled to the mixing unit. Optionally, a portion of the devolatilized biocoke is recycled to the mixing unit. Optionally, a portion of the calcined biocoke is recycled to the mixing unit. The starting biocoke, fed to the mixing unit, may be obtained from another process and thus not obtained from any of the biocoke, devolatilized biocoke, or calcined biocoke. The biovapor may be sent to a condenser system, generating condensed bioliquid and non-condensable gas. Optionally, the condensed bioliquid may be recycled to the mixing unit. In some alternative embodiments, the starting biocoke in FIG. 4 is replaced by a starting coke, or a mixture of coke and biocoke.

Some variations of the invention provide a renewable biocoke product produced by a process comprising:
(a) providing a bioliquid feedstock;
(b) providing a recycled biocoke;
(c) feeding the bioliquid feedstock and the recycled biocoke into a biocoking reactor;
(d) feeding a reducing gas into the biocoking reactor, wherein the reducing gas contains H₂ and/or CO;
(e) within the biocoking reactor, chemically converting the bioliquid feedstock into biocoke by thermally cracking molecules of the bioliquid feedstock and nucleating the biocoke on particles of the recycled biocoke as a biocoking template, wherein the reducing gas reacts with at least some oxygen present in the bioliquid feedstock to form H₂O and/or CO₂;
(f) within a devolatilization unit, devolatilizing the biocoke to generate a devolatilized biocoke;
(g) within a calcination unit, or within the devolatilization unit, calcining the devolatilized biocoke to generate a calcined biocoke;
(h) recovering a portion of the biocoke, a portion of the devolatilized biocoke, a portion of the calcined biocoke, or a combination thereof, as the recycled biocoke for use in step (b); and
(i) recovering the calcined biocoke as a renewable biocoke product.

The renewable biocoke product may contain at least 80 wt % total carbon, at least 90 wt % total carbon, or at least 95 wt % total carbon. In some embodiments, the renewable biocoke product contains from about 90 wt % to about 99 wt % total carbon. In various embodiments, the renewable biocoke product contains about, or at least about, 80, 81, 82, 83, 84, 85, 86, 87, 88, 89, 90, 91, 92, 93, 94, 95, 96, 97, 98, or 99 wt %, including any intervening range.

The calcined biocoke is preferably a renewable biocoke product, according to a measurement of the ¹⁴C/¹²C isotopic ratio. The total carbon in the calcined biocoke is preferably at least 50% renewable as determined from a measurement of the ¹⁴C/¹²C isotopic ratio of the total carbon. More preferably, the total carbon in the calcined biocoke is at least 75% renewable as determined from a measurement of the ¹⁴C/¹²C isotopic ratio of the total carbon. Most preferably, the total carbon in the calcined biocoke is at least 90% renewable as determined from a measurement of the ¹⁴C/¹²C isotopic ratio of the total carbon. In various embodiments, the total carbon in the calcined biocoke is about, or at least about 50%, 55%, 60%, 65%, 70%, 75%, 80%, 81%, 82%, 83%, 84%, 85%, 86%, 87%, 88%, 89%, 90%, 91%, 92%, 93%, 94%, 95%, 96%, 97%, 98%, 99%, 99.5%, 99.9% renewable as determined from a measurement of the ¹⁴C/¹²C isotopic ratio of the total carbon. The measurement of the ¹⁴C/¹²C isotopic ratio of the calcined biocoke may utilize ASTM D6866, which is hereby incorporated by reference herein.

The renewable biocoke product may contain at least 50 wt %, at least 75 wt %, or at least 90 wt % crystalline graphite according to spectroscopy (e.g., XRD or Raman spectroscopy). These percentages are based on total weight of the renewable biocoke product, not just the carbon content. In various embodiments, the renewable biocoke product contains about, or at least about, 50, 55, 60, 65, 70, 75, 80, 85, 95, or 95 wt % crystalline graphite according to spectroscopy.

On the basis of carbon content only, the total carbon contained in the renewable biocoke product may be at least 75 wt %, at least 90 wt %, at least 95 wt %, or at least 99 wt % crystalline graphite according to spectroscopy. In various embodiments, the total carbon contained in the renewable biocoke product is about, or at least about, 75, 80, 85, 90, 95, or 99 wt % crystalline graphite according to spectroscopy.

The renewable biocoke product disclosed herein may be utilized in the production of a metal product. A metal product may include one or more metals, such as iron, copper, nickel, magnesium, manganese, aluminum, tin, zinc, cobalt, chromium, tungsten, molybdenum, titanium, gold, silver, lead, silicon, lithium, boron, zirconium, vanadium, platinum, palladium, rhodium, gallium, germanium, indium, bismuth, or combinations or alloys thereof. For this disclosure, silicon is considered to be a metal.

Some embodiments provide an electrode material comprising the disclosed renewable biocoke product. Some embodiments provide an electrode containing the electrode material. The electrode may be a battery electrode or a fuel cell electrode, for example. The electrode may be an electric arc furnace electrode, such as for production of iron, steel, or another metal or metal alloy. Graphite electrodes are an essential part of the electric arc furnace (EAF) steel production process and comprise a significant portion of cost, since graphite electrodes are typically consumed every 8-12 hours in continuous EAF-based steel production.

The electrode may be used in aluminum production. Aluminum is usually produced electrolytically by using anodes and cathodes. Alumina (Al₂O₃) powder is dissolved in a molten bath of sodium aluminum fluoride. Electrical current is passed between carbon anodes and a carbon cathode in the cell, reducing alumina to aluminum (Al) metal that deposits on the cathode surface. High-purity Al is recovered from the carbon cathode. Carbon anodes are consumed in the process, generating CO₂ gas (the oxygen content of that CO₂ is from the oxygen atoms in Al₂O₃). Note that the CO₂ gas contains renewable carbon when the cathode utilizes the renewable biocoke. In aluminum production, the renewable biocoke product disclosed herein may be used as the cathode, anode, or both.

Various uses of the renewable biocoke product in electrodes include applications in batteries, fuel cells, capacitors, and other energy-storage or energy-delivery devices. In a lithium-ion battery, the renewable biocoke product may be used on the anode side to intercalate lithium within the graphite crystal lattice or between graphene layers of the graphite.

Additional embodiments, variations, options, and features will now be further described, without limitation of the claimed invention.

Some embodiments utilize a biomass-containing feedstock for the production of the bioliquid feedstock. For example, a biomass-containing feedstock may be subjected to biomass pyrolysis to generate biocarbon and a pyrolysis vapor, which is condensed to provide the bioliquid feedstock.

In some embodiments, the biomass-containing feedstock is selected from softwood chips, hardwood chips, timber harvesting residue, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

The condenser system may be a thermally controlled multiple-stage separation system. In various embodiments, the thermally controlled multiple-stage separation system includes one or more filters, absorption beds with solid media, absorption beds with liquid media, adsorption beds with solid media, dry scrubbers, wet scrubbers, Venturi scrubbers, centrifuges, cyclones, quench units, reactive condensers, distillation columns, reactive-distillation columns, evaporators, reactive evaporators, heat exchangers, fan separators, electrostatic precipitators, demisters, or a combination thereof. The thermally controlled multiple-stage separation system may be configured for generating a liquid condensate and a non-condensable gas from the incoming vapor. The incoming vapor may be biovapor (exiting the biocoking reactor) and/or may be a biomass pyrolysis vapor (from a pyrolysis unit not shown in FIGS. 1-4).

In some embodiments, the thermally controlled multiple-stage separation system includes a cyclone unit configured for separating solid biocarbon-containing material from the incoming vapor, which again may be biovapor and/or biomass pyrolysis vapor.

In some embodiments, a quench unit is configured for exposing the incoming vapor to water, to generate the liquid condensate.

In some embodiments, the thermally controlled multiple-stage separation system includes a demister unit configured to recover residual liquid from the incoming vapor. The residual liquid is optionally combined with the liquid condensate (condensed bioliquid).

In some embodiments, the thermally controlled multiple-stage separation system is configured to capture multiple liquid fractions. The multiple liquid fractions may be separated according to molecular weight, boiling point, polarity, water content, or a combination thereof, for example. The liquid condensate may include at least two of the multiple liquid fractions in recombined form. In certain embodiments, at least one of the multiple liquid fractions is recovered as a light co-product that does not form part of the liquid condensate (condensed bioliquid).

The condensed bioliquid may contain a polyphenolic material. In some embodiments, the polyphenolic material contains from about 20 wt % to about 80 wt % fixed carbon. In certain embodiments, the polyphenolic material contains from about 40 wt % to about 60 wt % fixed carbon. In various embodiments, the polyphenolic material contains about, at least about, or at most about 20, 25, 30, 35, 40, 45, 50, 55, 60, 65, 70, 75, or 80 wt % fixed carbon, including any intervening range.

In some embodiments, the polyphenolic material has a weight-average molecular weight Mw from about 75 g/mol to about 50,000 g/mol. In certain embodiments, the polyphenolic material has a Mw from about 75 g/mol to about 1,000 g/mol. In certain embodiments, the polyphenolic material has a Mw from about 1,000 g/mol to about 50,000 g/mol. In various embodiments, the polyphenolic material has a Mw of about, at least about, or at most about 100, 200, 300, 400, 500, 1,000, 1,500, 2,000, 2,500, 3,000, 4,000, 5,000, 10,000, 15,000, 20,000, 25,000, 30,000, 35,000, 40,000, 45,000, or 50,000 g/mol, including any intervening range. It is believed that the polyphenolic material can have a high Mw due to polycondensation reactions that are thermodynamically and kinetically enhanced by the removal of water, leading to large number of monomer units within the polymer chain.

In some embodiments, the polyphenolic material has a viscosity at 25° C. from about 1 cP to about 1000 cP. In certain embodiments, the polyphenolic material has a viscosity at 25° C. from about 10 cP to about 500 cP. In various embodiments, the polyphenolic material has a viscosity at 25° C. of about, or at least about, 1, 2, 3, 4, 5, 10, 15, 20, 25, 50, 75, 100, 150, 200, 250, 300, 400, 500, 600, 700, 800, 900, or 1000 cP.

In some embodiments, the polyphenolic material contains from about 1 wt % to about 60 wt % water. This water content refers to bulk free water, as well as adsorbed water (·H₂O), but not potential formation of water from −H and −OH content in the polyphenolic material. In certain embodiments, the polyphenolic material contains from about 5 wt % to about 25 wt % water. In various embodiments, the polyphenolic material contains about, at least about, or at most about 0.1, 0.5, 1, 2, 3, 4, 5, 6, 7, 8, 9, 10, 15, 2025, 30, 35, 40, 45, 50, 55, 60, 65, or 70 wt % water, including any intervening range. Certain embodiments utilize a polyphenolic material that is a relatively dry condensate fraction. Such polyphenolic material may contain about 5 wt % water or less, about 4 wt % water or less, about 3 wt % water or less, about 2 wt % water or less, or about 1 wt % water or less. In principle, a polyphenolic material may be recovered that contains essentially no water, such as by using molecular sieves.

In some processes, the condensed bioliquid with polyphenolic material is heated prior to contacting with the recycled biocoke in the mixing unit. The condensed bioliquid may be heated to a temperature of at least about 150° C., at least about 200° C., or at least about 250° C., for example.

In some processes, the recycled biocoke is heated prior to contacting with the condensed bioliquid. The recycled biocoke may be controlled to be at a temperature within +100° C. or within +50° C. of the temperature of the applicable unit from which the biocoke was recycled, prior to contacting with the condensed bioliquid. Typically, the recycled biocoke slightly cools within the recycle line(s), so the recycled-biocoke temperature upon contacting with the condensed bioliquid is usually somewhat less than the biocoking, devolatilization, or calcination temperature; however, heating may be used to maintain or increase the temperature of the solid recycled biocoke.

In some embodiments, a densification unit is downstream of the calcination unit to densify the calcined biocoke. In some embodiments, a densification unit is between the devolatilization unit and the calcination unit, to densify the devolatilized biocoke. The densification unit may be selected from an extruder, a briquetter, a pellet mill, or a combination thereof, for example. In some embodiments, the densification unit is an extruder, such as a single-screw extruder or a twin-screw extruder.

The densification unit may be operated at a densification temperature greater than 100° C., such as at least 150° C. or at least 200° C. In various embodiments, the densification temperature is about, at least about, or at most about 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., or 300° C., including any intervening range.

The densification unit may be operated at a densification pressure of about, at least about, or at most about 1 bar, 2 bar, 3 bar, 4 bar, 5 bar, 10 bar, 15 bar, 20 bar, 25 bar, 30 bar, 35 bar, 40 bar, 45 bar, or 50 bar, including any intervening range.

The densification unit may be operated at a densification time of about, at least about, or at most about 1 minute, 5 minutes, 10 minutes, 15 minutes, 30 minutes, or 60 minutes, including any intervening range.

In some embodiments, the calcined biocoke has a moisture content from 0 wt % to about 10 wt % water. In certain embodiments, the calcined biocoke has a moisture content from 0 wt % to about 5 wt % water, or from 0 wt % to about 2 wt % water, or from 0 wt % to about 1 wt % water. In certain embodiments, the calcined biocoke has a moisture content from about 1 wt % to about 2 wt %. In various embodiments, the calcined biocoke has a moisture content of about, or at most about, 0.01, 0.05, 0.1, 0.2, 0.5, 1, 1.5, 2, 2.5, 3, 4, 5, 6, 7, 8, 9, or 10 wt %, including any intervening range.

In some embodiments, the calcined biocoke has an ash content from 1 wt % to about 5 wt % total ash. In certain embodiments, the calcined biocoke has an ash content of about, or at most about, 0.1, 0.5, 1, 2, 3, 4, 5, 6, 7, 8, 9, or 10 wt % ash, including any intervening range.

The calcined biocoke may be recovered in various forms, such as powder, particulates, pellets, briquettes, rods, sheets, or random geometries.

In some embodiments, the calcined biocoke is characterized by a bulk density of at least about 40 lb/ft³. In certain embodiments, the calcined biocoke is characterized by a bulk density of at least about 50 lb/ft³. In various embodiments, the calcined biocoke is characterized by a bulk density of about, or at least about, 40, 50, 60, 70, 80, 90, or 100 lb/ft³, including any intervening range.

In some embodiments, the calcined biocoke is subjected to milling. The milling may utilize a mechanical-treatment apparatus selected from a hammer mill, an extruder, an attrition mill, a disc mill, a pin mill, a ball mill, a cone crusher, a jaw crusher, or a combination thereof.

In some embodiments, the calcined biocoke is blended with an additive. Blending may utilize a relatively simple apparatus selected from a tumbler, a convective blender, a hopper blender, a fluidization mixer, or a combination thereof. Alternatively, or additionally, blending may utilize a mechanical-treatment apparatus selected from a hammer mill, an extruder, an attrition mill, a disc mill, a pin mill, a ball mill, a cone crusher, a jaw crusher, or a combination thereof.

When pellets of calcined biocoke are desired, a pelletization unit is employed either downstream of the calcination unit, or the calcination unit is configured to fabricate pellets. The pelletization unit may be selected from an extruder, a ring die pellet mill, a flat die pellet mill, a roll compactor, a roll briquetter, a wet agglomeration mill, a dry agglomeration mill, or a combination thereof.

When the calcined biocoke is in the form of pellets, for some applications, mechanical durability is important. In some embodiments, the calcined biocoke is in the form of pellets characterized by a pellet compressive strength at 25° C. of at least about 100 lb_{f}/in². In certain embodiments, the pellets are characterized by a pellet compressive strength at 25° C. of at least about 200 lb_{f}/in². In various embodiments, the pellets are characterized by a pellet compressive strength at 25° C. of about, or at least about, 50, 75, 100, 125, 150, 175, 200, 225, 250, 275, or 300 lb_{f}/in², including any intervening range. The units of lb_{f}/in² (psi) are pound-force per square inch. The pellet compressive strength is calculated as compression force at pellet breakage divided by lateral area of the pellet. The lateral area of the pellet is the area along the length of the pellet that is exposed to the compressive force, and not counting the pellet sides that are not exposed to the compressive force. In the case of a perfectly spherical pellet, the lateral area is the sphere surface area. In the case of a cylindrical pellet, the lateral area is the area along the length of the cylinder, and does not include the area at the two ends of the cylinder. The pellet compressive strength may be measured using a laboratory tensile and compression load tester, for example. Pellet breakage is also known as pellet rupture or pellet crushing and may be automatically detected by the laboratory tensile and compression load tester.

The pellet compressive strength may also be measured after thermal exposure, which can be important to understand the mechanical durability of the calcined-biocoke pellet in high-temperature use. For example, the pellet compressive strength may also be measured after thermal exposure at 900° C. for 20 minutes in a low-oxygen environment. The pellet compressive strength after thermal exposure may be measured using a laboratory tensile and compression load tester, for example, after the test sample has cooled back down to room temperature (about 25° C.). In some embodiments, the pellet compressive strength after 20 minutes at 900° C. is at least about 30 lb_{f}/in², preferably at least about 60 lb_{f}/in², measured after cooling back down to 25° C. In various embodiments, the pellet compressive strength after 20 minutes at 900° C. is about, or at least about 10, 20, 30, 40, 50, 60, 70, 80, or 90 lb_{f}/in², including any intervening ranges.

In some embodiments of a calcined-biocoke pellet, the pellet has a pellet shape selected from a sphere, a cylinder, a cube, an octagon, a hexagon, a honeycomb, an oval, a column, a bar, a pillow, a lentil, a random granular, or a combination thereof.

In some embodiments of a calcined-biocoke pellet, the pellet has a pellet size selected from about 1 mm to about 10 cm, calculated as effective diameter of the biocarbon pellet. In various embodiments, the biocarbon pellet has an effective diameter of about, at least about, or at most about 1 mm, 2 mm, 3 mm, 4 mm, 5 mm, 6 mm, 7 mm, 8 mm, 9 mm, 10 mm, 15 mm, 2 cm, 3 cm, 4 cm, 5 cm, 6 cm, 7 cm, 8 cm, 9 cm, or 10 cm, including any intervening range.

In some embodiments of a calcined-biocoke pellet, the biocarbon pellet is characterized by a low odor according to ASTM D1296. Another relevant odor test may be employed, including a simple qualitative test for odor. An olfactometer may be utilized to measure odor.

In some embodiments of a calcined-biocoke pellet, the pellet is characterized as non-self-heating when subjected to a self-heating test according to Manual of Tests and Criteria, Seventh revised edition 2019, United Nations, Page 375, 33.4.6 Test N.4: “Test method for self-heating substances”.

In some embodiments of a calcined-biocoke pellet, a pellet binder is employed. For example, a pelletization unit may be downstream of the calcination unit, to receive the calcined biocoke and also receive a pellet binder, and to generate calcined-biocoke pellets. The pellet binder, when present, may be selected from starch, thermoplastic starch, crosslinked starch, starch polymers, cellulose, cellulose ethers, hemicellulose, methylcellulose, chitosan, lignin, lactose, sucrose, dextrose, maltodextrin, banana flour, wheat flour, wheat starch, soy flour, corn flour, wood flour, coal tars, coal fines, met coke, asphalt, coal-tar pitch, petroleum pitch, bitumen, pyrolysis tars, gilsonite, bentonite clay, borax, limestone, lime, waxes, vegetable waxes, baking soda, baking powder, sodium hydroxide, potassium hydroxide, iron ore concentrate, silica fume, gypsum, Portland cement, guar gum, xanthan gum, polyvidones, polyacrylamides, polylactides, phenol-formaldehyde resins, vegetable resins, recycled shingles, recycled tires, recycled cardboard, recycled paper, derivatives thereof, or any combination of the foregoing.

In some embodiments, a pellet binder is selected from starch, thermoplastic starch, crosslinked starch, starch polymers, derivatives thereof, or any combinations of the foregoing. The pellet binder may be a thermoplastic starch that is optionally crosslinked. The thermoplastic starch may be a reaction product of starch and a polyol. The polyol may be selected from ethylene glycol, propylene glycol, glycerol, butanediols, butanetriols, erythritol, xylitol, sorbitol, or a combination thereof. The reaction product may be formed from a reaction that is catalyzed by an acid. The acid may be selected from formic acid, acetic acid, lactic acid, citric acid, oxalic acid, uronic acids, glucuronic acids, or a combination thereof. Alternatively, the reaction product may be formed from a reaction that is catalyzed by a base.

The calcined-biocoke pellets may have a Hardgrove Grindability Index (HGI) of at least about 30, at least about 40, or at least about 50. In various embodiments, the pellets have a Hardgrove Grindability Index from about 30 to about 100. In various embodiments, the pellets have a Hardgrove Grindability Index of about, at least about, or at most about 20, 30, 40, 50, 60, 70, 80, 90, 100, 110, or 120, including any intervening ranges. ASTM-Standard D 409/D 409M for “Standard Test Method for Grindability of Coal by the Hardgrove-Machine Method” is hereby incorporated by reference herein in its entirety. Unless otherwise indicated, all references in this disclosure to Hardgrove Grindability Index or HGI are in reference to ASTM-Standard D 409/D 409M.

The calcined-biocoke pellets may have a Pellet Durability Index (PDI) of at least about 80%, at least about 85%, at least about 90%, or at least about 95%. In various embodiments, the pellet have a Pellet Durability Index of about, at least about, or at most about 70%, 75%, 80%, 85%, 90%, 91%, 92%, 93%, 94%, 95%, 96%, 97%, 98%, or 99%, including any intervening ranges. Unless otherwise indicated, all references in this disclosure to Pellet Durability Index are in reference to ISO 17831-1:2015 “Solid biofuels-Determination of mechanical durability of pellets and briquettes—Part 1: Pellets”, which is hereby incorporated by reference herein in its entirety.

The calcined biocoke may contain one or more additives for various purposes, such as for reduced flammability. The calcined biocoke may be characterized as non-self-heating when subjected to a self-heating test according to Manual of Tests and Criteria, Seventh revised edition 2019, United Nations, Page 375, 33.4.6 Test N.4: “Test method for self-heating substances”, which is hereby incorporated by reference herein.

In various embodiments, the concentration of additives within the calcined biocoke may be about, at least about, or at most about, 0, 1, 2, 3, 4, 5, 6, 7, 8, 9, 10, 15, 20, 25, 30, 35, 40, 45 or 50 wt %, including any intervening range. When additives are employed, the additives do not need to be uniformly distributed throughout the calcined biocoke composition.

Additives may be introduced at any point in the process. In some embodiments, the additive type and/or concentration are selected to optimize electronic conductivity associated with the calcined biocoke. In some embodiments, the additive type and/or concentration are selected to optimize ionic conductivity associated with the calcined biocoke. In some embodiments, the additive type and/or concentration are selected to optimize combined electronic-ionic conductivity associated with the calcined biocoke. In some embodiments, the additive type and/or concentration are selected to optimize energy content associated with the calcined biocoke. In some embodiments, the additive type and/or concentration are selected to optimize bulk density associated with the calcined biocoke. In some embodiments, the additive type and/or concentration are selected to optimize hydrophobicity associated with the calcined biocoke. In some embodiments, the additive type and/or concentration are selected to optimize pore sizes associated with the calcined biocoke. In some embodiments, the additive type and/or concentration are selected to optimize ratios of pore sizes associated with the calcined biocoke. In some embodiments, the additive type and/or concentration are selected to optimize surface area associated with the calcined biocoke. In some embodiments, the additive type and/or concentration are selected to optimize reactivity associated with the calcined biocoke. In some embodiments, the additive type and/or concentration are selected to optimize ion-exchange capacity associated with the calcined biocoke. In some embodiments, the additive type and/or concentration are selected to optimize Hardgrove Grindability Index associated with calcined biocoke pellets. In some embodiments, the additive type and/or concentration are selected to optimize Pellet Durability Index associated with calcined biocoke pellets.

Imaging and spectroscopy may be used to analyze the calcined biocoke (whether or not in pellet form), or any process intermediates. Imaging techniques may include, but are not limited to, optical microscopy; dark-field microscopy; scanning electron microscopy (SEM); transmission electron microscopy (TEM); and X-ray tomography (XRT), for example. Spectroscopy techniques may include, but are not limited to, energy dispersive X-ray spectroscopy (EDS), X-ray fluorescence (XRF), infrared (IR) spectroscopy; and nuclear magnetic resonance (NMR) spectroscopy, for example.

### Biomass Pyrolysis

Processes and systems suitable for pyrolyzing a biomass feedstock to generate a biogenic reagent will now be further described in detail. References herein to “biocarbon reagent” will be understood, in various instances, as references to biogenic carbon or a biocarbon composition containing biogenic carbon, depending on the context. In the present disclosure, the biogenic reagent may be used in a variety of ways. The biogenic reagent may be used as a bioliquid feedstock, especially when pyrolysis conditions are selected to maximize liquid production (e.g., pyrolysis oil) relative to solid production. The biogenic reagent may be recovered and sold as a biocarbon co-product from biomass pyrolysis, while the vapor from biomass pyrolysis is condensed and used as the bioliquid feedstock. The biogenic reagent may be gasified, to generate a reducing gas that may then be fed to the biocoking reactor. Combinations of the foregoing are also possible. It is also possible that no biomass pyrolysis is conducted at all—instead utilizing a bioliquid feedstock not from pyrolysis, and utilizing a reducing gas not from gasifying a biogenic reagent.

“Pyrolysis” and “pyrolyze” generally refer to thermal decomposition of a carbonaceous material. In pyrolysis, less oxygen is present than is required for complete combustion of the material, such as less than 10%, 5%, 1%, 0.5%, 0.1%, or 0.01% of the oxygen (O₂ molar basis) that is required for complete combustion. In some embodiments, pyrolysis is performed in the absence of oxygen.

Exemplary changes that may occur during pyrolysis include any of the following: (i) heat transfer from a heat source increases the temperature inside the feedstock; (ii) the initiation of primary pyrolysis reactions at this higher temperature releases volatiles and forms a char; (iii) the flow of hot volatiles toward cooler solids results in heat transfer between hot volatiles and cooler unpyrolyzed feedstock; (iv) condensation of some of the volatiles in the cooler parts of the feedstock, followed by secondary reactions, can produce tar; (v) autocatalytic secondary pyrolysis reactions proceed while primary pyrolytic reactions simultaneously occur in competition; and (vi) further thermal decomposition, reforming, water-gas shift reactions, free-radical recombination, and/or dehydrations can also occur, which are a function of the residence time, temperature, and pressure profile.

Pyrolysis can at least partially dehydrate a starting feedstock (e.g., lignocellulosic biomass). In various embodiments, pyrolysis removes greater than about 50%, 75%, 90%, 95%, 99%, or more of the water from the starting feedstock.

In some embodiments, a starting biomass feedstock is selected from the softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction and/or demolition waste, lignin, animal manure, municipal solid waste, municipal sewage, or a combination thereof. Note that typically a biomass feedstock contains at least carbon, hydrogen, and oxygen.

The biogenic reagent may comprise at least about 50 wt %, at least about 75 wt %, or at least about 90 wt % total carbon. In various embodiments, the biogenic reagent contains about, at least about, or at most about 20, 25, 30, 35, 40, 45, 50, 55, 60, 65, 70, 75, 80, 85, 90, 95, or 99 wt % carbon. The total carbon is fixed carbon plus non-fixed carbon that is present in volatile matter. In some embodiments, component weight percentages are on an absolute basis, which is assumed unless stated otherwise. In other embodiments, component weight percentages are on a moisture-free and ash-free basis.

The pyrolysis conditions may be varied widely, depending on the desired compositions for the biogenic reagent and pyrolysis off-gas, the starting feedstock, the reactor configuration, and other factors.

In some embodiments, multiple reactor zones are designed and operated in a way that optimizes carbon yield and product quality from pyrolysis, while maintaining flexibility and adjustability for feedstock variations and product requirements.

In some non-limiting embodiments, the temperatures and residence times are preferably selected to achieve relatively slow pyrolysis chemistry. The benefit is potentially the substantial preservation of cell walls contained in the biomass structure, which means the final product can retain some, most, or all of the shape and strength of the starting biomass. In order to maximize this potential benefit, it is preferred to utilize apparatus that does not mechanically destroy the cell walls or otherwise convert the biomass particles into small fines. Preferred reactor configurations are discussed following the process description below.

Additionally, if the feedstock is a milled or sized feedstock, such as wood chips or pellets, it may be desirable for the feedstock to be carefully milled or sized. Careful initial treatment will tend to preserve the strength and cell-wall integrity that is present in the native feedstock source (e.g., trees). This can also be important when the final product should retain some, most, or all of the shape and strength of the starting biomass.

In some embodiments, a first zone of a pyrolysis reactor is configured for feeding biomass (or another carbon-containing feedstock) in a manner that does not “shock” the biomass, which would rupture the cell walls and initiate fast decomposition of the solid phase into vapors and gases. This first zone can be thought of as mild pyrolysis.

In some embodiments, a second zone of a pyrolysis reactor is configured as the primary reaction zone, in which preheated biomass undergoes pyrolysis chemistry to release gases and condensable vapors, leaving a significant amount of solid material which is a high-carbon reaction intermediate. Biomass components (primarily cellulose, hemicellulose, and lignin) decompose and create vapors, which escape by penetrating through pores or creating new nanopores. The latter effect contributes to the creation of porosity and surface area.

In some embodiments, a third zone of a pyrolysis reactor is configured for receiving the high-carbon reaction intermediate and cooling down the solids to some extent. Typically, the third zone will be a lower temperature than the second zone. In the third zone, the chemistry and mass transport can be surprisingly complex. Without being limited by any particular theory or proposed mechanisms, it is believed that secondary reactions may occur in the third zone. Essentially, carbon-containing components that are in the gas phase can decompose to form additional fixed carbon and/or become adsorbed onto the carbon. Thus, the final carbonaceous material may not simply be the solid, devolatilized residue of the processing steps, but rather may include additional carbon that has been deposited from the gas phase, such as by decomposition of organic vapors (e.g., tars) that can form carbon.

Certain embodiments extend the concept of additional carbon formation by including a separate unit in which cooled carbon is subjected to an environment including carbon-containing species, to enhance the carbon content of the final product. When the temperature of this unit is below pyrolysis temperatures, the additional carbon is expected to be in the form of adsorbed carbonaceous species, rather than additional fixed carbon.

There are a large number of options as to intermediate input and output (purge or probe) streams of one or more phases present in any particular zone, various mass and energy recycle schemes, various additives that may be introduced anywhere in the process, adjustability of process conditions including both reaction and separation conditions in order to tailor product distributions, and so on. Zone-specific input and output streams enable good process monitoring and control, such as through FTIR sampling and dynamic process adjustments.

Some embodiments do not employ fast pyrolysis, and some embodiments do not employ slow pyrolysis. Surprisingly high-quality carbon materials, including compositions with very high fractions of fixed carbon, may be obtained from the disclosed processes and systems.

In some embodiments, a pyrolysis process for producing a biogenic reagent comprises the following steps:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) pyrolyzing the feedstock in the presence of a substantially inert gas phase for at least 10 minutes and with at least one temperature selected from about 250° C. to about 700° C., to generate hot pyrolyzed solids, condensable vapors, and non-condensable gases;
(e) separating at least a portion of the condensable vapors and at least a portion of the non-condensable gases from the hot pyrolyzed solids;
(f) cooling the hot pyrolyzed solids to generate cooled pyrolyzed solids; and
(g) recovering a biogenic reagent comprising at least a portion of the cooled pyrolyzed solids.

“Biomass,” for purposes of this disclosure, shall be construed as any biogenic feedstock or mixture of a biogenic and non-biogenic feedstocks. Elementally, biomass includes at least carbon, hydrogen, and oxygen. The methods and apparatus of the invention can accommodate a wide range of feedstocks of various types, sizes, and moisture contents.

Biomass includes, for example, plant and plant-derived material, vegetation, agricultural waste, forestry waste, wood waste, paper waste, animal-derived waste, poultry-derived waste, and municipal solid waste. In various embodiments of the invention utilizing biomass, the biomass feedstock may include one or more materials selected from: timber harvesting residues, softwood chips, hardwood chips, tree branches, tree stumps, knots, leaves, bark, sawdust, off-spec paper pulp, cellulose, corn, corn stover, wheat straw, rice straw, sugarcane bagasse, switchgrass, miscanthus, animal manure, municipal garbage, municipal sewage, commercial waste, grape pumice, almond shells, pecan shells, coconut shells, coffee grounds, grass pellets, hay pellets, wood pellets, cardboard, paper, carbohydrates, plastic, and cloth. A person of ordinary skill in the art will readily appreciate that the feedstock options are virtually unlimited.

Some embodiments employ carbon-containing feedstocks other than biomass, such as a fossil fuel (e.g., coal or petroleum coke), or any mixtures of biomass and fossil fuels (such as biomass/coal blends). In some embodiments, a feedstock is, or includes, coal, oil shale, crude oil, asphalt, or solids from crude-oil processing (such as petcoke). Feedstocks may include waste tires, recycled plastics, recycled paper, construction waste, deconstruction waste, and other waste or recycled materials. Carbon-containing feedstocks may be transportable by any known means, such as by truck, train, ship, barge, tractor trailer, or any other vehicle or means of conveyance.

Selection of a particular feedstock or feedstocks is not regarded as technically critical, but is carried out in a manner that tends to favor an economical process as well as a low-carbon-intensity, renewable process.

Typically, regardless of the feedstocks chosen, there can be (in some embodiments) screening to remove undesirable materials. The feedstock can optionally be dried prior to processing.

The feedstock employed may be provided or processed into a wide variety of particle sizes or shapes. For example, the feed material may be a fine powder, or a mixture of fine and coarse particles. The feed material may be in the form of large pieces of material, such as wood chips or other forms of wood (e.g., round, cylindrical, square, etc.). In some embodiments, the feed material comprises pellets or other agglomerated forms of particles that have been pressed together or otherwise bound, such as with a binder.

It is noted that size reduction is a costly and energy-intensive process. Pyrolyzed material can be sized with significantly less energy input—that is, it can be preferred to reduce the particle size of the product, not the feedstock. This is an option in the present invention because the process does not require a fine starting material, and there is not necessarily any significant particle-size reduction during processing. The ability to process very large pieces of feedstock is a significant economic advantage of this invention. Notably, some market applications of the high-carbon product actually require large sizes (e.g., on the order of centimeters), so that in some embodiments, large pieces are fed, produced, and sold.

When it is desired to produce a final carbonaceous biogenic reagent that has structural integrity, such as in the form of cylinders, there are at least two options in the context of this invention. First, the material produced from the process may be collected and then further process mechanically into the desired form. For example, the product may be pressed or pelletized, with a binder. The second option is to utilize feed materials that generally possess the desired size and/or shape for the final product, and employ processing steps that do not destroy the basic structure of the feed material. In some embodiments, the feed and product have similar geometrical shapes, such as spheres, cylinders, or cubes.

The ability to maintain the approximate size of feed material throughout the process is beneficial when product strength is important. Also, this avoids the difficulty and cost of pelletizing high fixed-carbon materials.

The starting feed material may be provided with a range of moisture levels, as will be appreciated. In some embodiments, the feed material may already be sufficiently dry that it need not be further dried before pyrolysis. Typically, it will be desirable to utilize commercial sources of biomass which will usually contain moisture, and feed the biomass through a drying step before introduction into the pyrolysis reactor. However, in some embodiments a dried feedstock may be utilized.

It is usually desirable to provide a relatively low-oxygen environment in the pyrolysis reactor, such as about, or at most about, 10 mol %, 5 mol %, 4 mol %, 3 mol %, 2 mol %, 1.5 mol %, 1 mol %, 0.5 mol %, 0.2 mol %, 0.1 mol %, 0.05 mol %, 0.02 mol %, or 0.01 mol % O₂ in the gas phase. First, uncontrolled combustion should be avoided in the pyrolysis reactor, for safety reasons. Some amount of total carbon oxidation to CO₂ may occur, and the heat released from the exothermic oxidation may assist the endothermic pyrolysis chemistry. Large amounts of oxidation of carbon, including partial oxidation to syngas, will reduce the carbon yield to solids.

Practically speaking, it can be difficult to achieve a strictly oxygen-free environment in the reactor. This limit can be approached, and in some embodiments, the reactor is substantially free of molecular oxygen in the gas phase. To ensure that little or no oxygen is present in the pyrolysis reactor, it may be desirable to remove air from the feed material before it is introduced to the reactor. There are various ways to remove or reduce air in the feedstock.

In some embodiments, a deaeration unit is utilized in which feedstock, before or after drying, is conveyed in the presence of another gas which can remove adsorbed oxygen and penetrate the feedstock pores to remove oxygen from the pores. Essentially any gas that has lower than 21 vol % O₂ may be employed, at varying effectiveness. In some embodiments, nitrogen is employed. In some embodiments, CO and/or CO₂ is employed. Mixtures may be used, such as a mixture of nitrogen and a small amount of oxygen. Steam may be present in the deaeration gas, although adding significant moisture back to the feed should be avoided. The effluent from the deaeration unit may be purged (to the atmosphere or to an emissions treatment unit) or recycled.

In principle, the effluent (or a portion thereof) from the deaeration unit could be introduced into the pyrolysis reactor itself since the oxygen removed from the solids will now be highly diluted. In this embodiment, it may be advantageous to introduce the deaeration effluent gas to the last zone of the reactor, when it is operated in a countercurrent configuration.

Various types of deaeration units may be employed. If drying it to be performed, it may be preferable to dry and then deaerate since it may be inefficient to scrub soluble oxygen out of the moisture present. In certain embodiments, the drying and deaerating steps are combined into a single unit, or some amount of deaeration is achieved during drying, and so on.

The optionally dried and optionally deaerated feed material is introduced to a pyrolysis reactor or multiple reactors in series or parallel. The feed material may be introduced using any known means, including screw feeders or lock hoppers, for example. In some embodiments, a material feed system incorporates an air knife.

When a single reactor is employed, preferably multiple zones are present. Multiple zones, such as two, three, four, or more zones, can allow for the separate control of temperature, solids residence time, gas residence time, gas composition, flow pattern, and/or pressure in order to adjust the overall process performance.

References to “zones” shall be broadly construed to include regions of space within a single physical unit, physically separate units, or any combination thereof. For a continuous reactor, the demarcation of zones may relate to structure, such as the presence of flights within the reactor or distinct heating elements to provide heat to separate zones. Alternatively, or additionally, the demarcation of zones in a continuous reactor may relate to function, such as distinct temperatures, fluid flow patterns, solid flow patterns, extent of reaction, and so on. In a single batch reactor, “zones” are operating regimes in time, rather than in space. Multiple batch reactors may also be used.

It will be appreciated that there are not necessarily abrupt transitions from one zone to another zone. For example, the boundary between the preheating zone and pyrolysis zone may be somewhat arbitrary; some amount of pyrolysis may take place in a portion of the preheating zone, and some amount of “preheating” may continue to take place in the pyrolysis zone. The temperature profile in the reactor is typically continuous, including at zone boundaries within the reactor.

Some embodiments employ a first zone that is operated under conditions of preheating and/or mild pyrolysis. The temperature of the first zone may be selected from about 150° C. to about 500° C., such as about 300° C. to about 400° C. The temperature of the first zone is preferably not so high as to shock the biomass material which ruptures the cell walls and initiates fast decomposition of the solid phase into vapors and gases.

All references to zone temperatures in this specification should be construed in a non-limiting way to include temperatures that may apply to the bulk solids present, or the gas phase, or the reactor walls (on the process side). It will be understood that there will be a temperature gradient in each zone, both axially and radially, as well as temporally (i.e., following start-up or due to transients). Thus, references to zone temperatures may be references to average temperatures or other effective temperatures that may influence the actual kinetics. Temperatures may be directly measured by thermocouples or other temperature probes, or indirectly measured or estimated by other means.

The second zone, or in general the primary pyrolysis zone, is operated under conditions of pyrolysis or carbonization. The temperature of the second zone may be selected from about 250° C. to about 700° C., such as about, or at least about, or at most about 300° C., 350° C., 400° C., 450° C., 500° C., 550° C., 600° C., or 650° C. Within this zone, preheated biomass undergoes pyrolysis chemistry to release gases and condensable vapors, leaving a significant amount of solid material as a high-carbon reaction intermediate. Biomass components (primarily cellulose, hemicellulose, and lignin) decompose and create vapors, which escape by penetrating through pores or creating new pores. The preferred temperature will at least depend on the residence time of the second zone, as well as the nature of the feedstock and desired product properties.

The third zone, or cooling zone, is operated to cool down the high-carbon reaction intermediate to varying degrees. At a minimum, the temperature of the third zone should be a lower temperature than that of the second zone. The temperature of the third zone may be selected from about 100° C. to about 550° C., such as about 150° C. to about 350° C.

Chemical reactions may continue to occur in the cooling zone. Without being limited by any particular theory, it is believed that secondary pyrolysis reactions may be initiated in the third zone. Carbon-containing components that are in the gas phase can condense (due to the reduced temperature of the third zone). The temperature remains sufficiently high, however, to promote reactions that may form additional fixed carbon from the condensed liquids (secondary pyrolysis) or at least form bonds between adsorbed species and the fixed carbon. One exemplary reaction that may take place is the Boudouard reaction for conversion of carbon monoxide to carbon dioxide plus fixed carbon.

The residence times of the reactor zones may vary. There is an interplay of time and temperature, so that for a desired amount of pyrolysis, higher temperatures may allow for lower reaction times, and vice versa. The residence time in a continuous reactor (zone) is the volume divided by the volumetric flow rate. The residence time in a batch reactor is the batch reaction time, following heating to reaction temperature.

It should be recognized that in multiphase reactors, there are multiple residence times. In the present context, in each zone, there will be a residence time (and residence-time distribution) of both the solids phase and the vapor phase. For a given apparatus employing multiple zones, and with a given throughput, the residence times across the zones will generally be coupled on the solids side, but residence times may be uncoupled on the vapor side when multiple inlet and outlet ports are utilized in individual zones. The solids and vapor residence times are uncoupled.

The solids residence time of the preheating zone may be selected from about 5 min to about 60 min, such as about 10, 20, 30, 40, or 50 min. Depending on the temperature, sufficient time is desired to allow the biomass to reach a desired preheat temperature. The heat-transfer rate, which will depend on the particle type and size, the physical apparatus, and on the heating parameters, will dictate the minimum residence time necessary to allow the solids to reach a desired preheat temperature. Additional time may not be desirable as it would contribute to higher capital cost, unless some amount of mild pyrolysis is intended in the preheating zone.

The solids residence time of the pyrolysis zone may be selected from about 10 min to about 120 min, such as about 20, 30, 40, 50, 60, 70, 80, 90, or 100 min. Depending on the pyrolysis temperature in this zone, there should be sufficient time to allow the carbonization chemistry to take place, following the necessary heat transfer. For times below about 10 min, in order to remove high quantities of non-carbon elements, the temperature would need to be quite high, such as above 700° C. This temperature would promote fast pyrolysis and its generation of vapors and gases derived from the carbon itself, which is to be avoided when the intended product is solid carbon.

In a static system, there would be an equilibrium conversion that could be substantially reached at a certain time. When, as in certain embodiments, vapor is continuously flowing over solids with continuous volatiles removal, the equilibrium constraint may be removed to allow for pyrolysis and devolatilization to continue until reaction rates approach zero. Longer times would not tend to substantially alter the remaining recalcitrant solids.

The solids residence time of the cooling zone may be selected from about 5 min to about 60 min, such as about 10, 20, 30, 40, or 50 min. Depending on the cooling temperature in this zone, there should be sufficient time to allow the carbon solids to cool to the desired temperature. The cooling rate and temperature will dictate the minimum residence time necessary to allow the carbon to be cooled. Additional time may not be desirable, unless some amount of secondary pyrolysis is desired.

As discussed above, the residence time of the vapor phase may be separately selected and controlled. The vapor residence time of the preheating zone may be selected from about 0.1 min to about 15 min, such as about 0.5, 1, 2, 3, 4, 5, 6, 7, 8, 9, or 10 min. The vapor residence time of the pyrolysis zone may be selected from about 0.1 min to about 20 min, such as about 0.5, 1, 2, 3, 4, 5, 6, 7, 8, 9, 10, 11, 12, 13, 14, or 15 min. The vapor residence time of the cooling zone may be selected from about 0.1 min to about 15 min, such as about 0.5, 1, 2, 3, 4, 5, 6, 7, 8, 9, or 10 min. Short vapor residence times promote fast sweeping of volatiles out of the system, while longer vapor residence times promote reactions of components in the vapor phase with the solid phase.

The mode of operation for the reactor, and overall system, may be continuous, semi-continuous, batch, or any combination or variation of these. In some embodiments, the reactor is a continuous, countercurrent reactor in which solids and vapor flow substantially in opposite directions. The reactor may also be operated in batch but with simulated countercurrent flow of vapors, such as by periodically introducing and removing gas phases from the batch vessel.

Various flow patterns may be desired or observed. With chemical reactions and simultaneous separations involving multiple phases in multiple reactor zones, the fluid dynamics can be quite complex. Typically, the flow of solids may approach plug flow (well-mixed in the radial dimension) while the flow of vapor may approach fully mixed flow (fast transport in both radial and axial dimensions). Multiple inlet and outlet ports for vapor may contribute to overall mixing.

The pressure in each zone may be separately selected and controlled. The pressure of each zone may be independently selected from about 1 kPa to about 3000 kPa, such as about 101.3 kPa (normal atmospheric pressure). Independent zone control of pressure is possible when multiple gas inlets and outlets are used, including vacuum ports to withdraw gas when a zone pressure less than atmospheric is desired.

The process may conveniently be operated at atmospheric pressure, in some embodiments. There are many advantages associated with operation at atmospheric pressure, ranging from mechanical simplicity to enhanced safety. In certain embodiments, the pyrolysis zone is operated at a pressure of about 90 kPa, 95 kPa, 100 kPa, 101 kPa, 102 kPa, 105 kPa, or 110 kPa (absolute pressures).

Vacuum operation (e.g., 10-100 kPa) would promote fast sweeping of volatiles out of the system. Higher pressures (e.g., 100-1000 kPa) may be useful when the off-gases will be fed to a high-pressure operation. Elevated pressures may also be useful to promote heat transfer, chemistry, or separations.

The step of separating at least a portion of the condensable vapors and at least a portion of the non-condensable gases from the hot pyrolyzed solids may be accomplished in the reactor itself, or using a distinct separation unit. A substantially inert sweep gas may be introduced into one or more of the zones. Condensable vapors and non-condensable gases are then carried away from the zone(s) in the sweep gas, and out of the reactor.

The sweep gas may be N₂, Ar, CO, CO₂, H₂, H₂O, CH₄, other light hydrocarbons, or combinations thereof, for example. The sweep gas may first be preheated prior to introduction, or possibly cooled if it is obtained from a heated source.

The sweep gas more thoroughly removes volatile components, by getting them out of the system before they can condense or further react. The sweep gas allows volatiles to be removed at higher rates than would be attained merely from volatilization at a given process temperature. Or, use of the sweep gas allows milder temperatures to be used to remove a certain quantity of volatiles. The reason the sweep gas improves the volatiles removal is that the mechanism of separation is not merely relative volatility but rather liquid/vapor phase disengagement assisted by the sweep gas. The sweep gas can both reduce mass-transfer limitations of volatilization as well as reduce thermodynamic limitations by continuously depleting a given volatile species, to cause more of it to vaporize in order to attain thermodynamic equilibrium.

Some embodiments remove gases laden with volatile organic carbon from subsequent processing stages, in order to produce a product with high fixed carbon. Without removal, the volatile carbon can adsorb or absorb onto the pyrolyzed solids, thereby requiring additional energy (cost) to achieve a purer form of carbon which may be desired. By removing vapors quickly, it is also speculated that porosity may be enhanced in the pyrolyzing solids. Higher porosity is desirable for some products.

In certain embodiments, the sweep gas in conjunction with a relatively low process pressure, such as atmospheric pressure, provides for fast vapor removal without large amounts of inert gas necessary.

In some embodiments, the sweep gas flows countercurrent to the flow direction of feedstock. In other embodiments, the sweep gas flows co-current to the flow direction of feedstock. In some embodiments, the flow pattern of solids approaches plug flow while the flow pattern of the sweep gas, and gas phase generally, approaches fully mixed flow in one or more zones.

The sweep may be performed in any one or more of the reactor zones. In some embodiments, the sweep gas is introduced into the cooling zone and extracted (along with volatiles produced) from the cooling and/or pyrolysis zones. In some embodiments, the sweep gas is introduced into the pyrolysis zone and extracted from the pyrolysis and/or preheating zones. In some embodiments, the sweep gas is introduced into the preheating zone and extracted from the pyrolysis zone. In these or other embodiments, the sweep gas may be introduced into each of the preheating, pyrolysis, and cooling zones and also extracted from each of the zones.

In some embodiments, the zone or zones in which separation is carried out is a physically separate unit from the reactor. The separation unit or zone may be disposed between reactor zones, if desired. For example, there may be a separation unit placed between pyrolysis and cooling units.

The sweep gas may be introduced continuously, especially when the solids flow is continuous. When the pyrolysis reaction is operated as a batch process, the sweep gas may be introduced after a certain amount of time, or periodically, to remove volatiles. Even when the pyrolysis reaction is operated continuously, the sweep gas may be introduced semi-continuously or periodically, if desired, with suitable valves and controls.

The volatiles-containing sweep gas may exit from the one or more reactor zones, and may be combined if obtained from multiple zones. The resulting gas stream, containing various vapors, may then be fed to a thermal oxidizer for control of air emissions. Any known thermal-oxidation unit may be employed. In some embodiments, the thermal oxidizer is fed with natural gas and air, to reach sufficient temperatures for substantial destruction of volatiles contained therein.

The effluent of the thermal oxidizer will be a hot gas stream comprising water, carbon dioxide, and nitrogen. This effluent stream may be purged directly to air emissions, if desired. Preferably, the energy content of the thermal oxidizer effluent is recovered, such as in a waste-heat recovery unit. The energy content may also be recovered by heat exchange with another stream (such as the sweep gas). The energy content may be utilized by directly or indirectly heating, or assisting with heating, a unit elsewhere in the process, such as the dryer or the reactor. In some embodiments, essentially all of the thermal oxidizer effluent is employed for indirect heating (utility side) of the dryer. The thermal oxidizer may employ other fuels than natural gas.

The yield of carbonaceous material may vary, depending on the above-described factors including type of feedstock and process conditions. In some embodiments, the net yield of solids as a percentage of the starting feedstock, on a dry basis, is at least 25%, 30%, 35%, 40%, 45%, 50%, or higher. The remainder will be split between condensable vapors, such as terpenes, tars, alcohols, acids, aldehydes, or ketones; and non-condensable gases, such as carbon monoxide, hydrogen, carbon dioxide, and methane. The relative amounts of condensable vapors compared to non-condensable gases will also depend on process conditions, including the water present.

In terms of the carbon balance, in some embodiments the net yield of carbon as a percentage of starting carbon in the feedstock is at least 25%, 30%, 40%, 50%, 60%, 65%, 70%, 75%, 80%, or higher. For example, the in some embodiments the carbonaceous material contains between about 40% and about 70% of the carbon contained in the starting feedstock. The rest of the carbon results in the formation of methane, carbon monoxide, carbon dioxide, light hydrocarbons, aromatics, tars, terpenes, alcohols, acids, aldehydes, or ketones, to varying extents.

In alternative embodiments, some portion of these compounds is combined with the carbon-rich solids to enrich the carbon and energy content of the product. In these embodiments, some or all of the resulting gas stream from the reactor, containing various vapors, may be condensed, at least in part, and then passed over cooled pyrolyzed solids derived from the cooling zone and/or from the separate cooling unit. These embodiments are described in more detail below.

Following the reaction and cooling within the cooling zone (if present), the carbonaceous solids may be introduced into a distinct cooling unit. In some embodiments, solids are collected and simply allowed to cool at slow rates. If the carbonaceous solids are reactive or unstable in air, it may be desirable to maintain an inert atmosphere and/or rapidly cool the solids to, for example, a temperature less than 40° C., such as ambient temperature. In some embodiments, a water quench is employed for rapid cooling. In some embodiments, a fluidized-bed cooler is employed. A “cooling unit” should be broadly construed to also include containers, tanks, pipes, or portions thereof.

In some embodiments, the process further comprises operating the cooling unit to cool the warm pyrolyzed solids with steam, thereby generating the cool pyrolyzed solids and superheated steam; wherein the drying is carried out, at least in part, with the superheated steam derived from the cooling unit. Optionally, the cooling unit may be operated to first cool the warm pyrolyzed solids with steam to reach a first cooling-unit temperature, and then with air to reach a second cooling-unit temperature, wherein the second cooling-unit temperature is lower than the first cooling-unit temperature and is associated with a reduced combustion risk for the warm pyrolyzed solids in the presence of the air.

Following cooling to ambient conditions, the carbonaceous solids may be recovered and stored, conveyed to another site operation, transported to another site, or otherwise disposed, traded, or sold. The solids may be fed to a unit to reduce particle size. A variety of size-reduction units are known in the art, including crushers, shredders, grinders, pulverizers, jet mills, pin mills, and ball mills.

Screening or some other means for separation based on particle size may be included. The grinding may be upstream or downstream of grinding, if present. A portion of the screened material (e.g., large chunks) may be returned to the grinding unit. The small and large particles may be recovered for separate downstream uses. In some embodiments, cooled pyrolyzed solids are ground into a fine powder, such as a pulverized carbon or activated carbon product.

Various additives may be introduced throughout the process, before, during, or after any step disclosed herein. The additives may be broadly classified as process additives, selected to improve process performance such as carbon yield or pyrolysis time/temperature to achieve a desired carbon purity; and product additives, selected to improve one or more properties of the biogenic reagent, or a downstream product incorporating the reagent. Certain additives may provide enhanced process and product (biogenic reagents or products containing biogenic reagents) characteristics.

Additives may be added before, during, or after any one or more steps of the process, including into the feedstock itself at any time, before or after it is harvested. Additive treatment may be incorporated prior to, during, or after feedstock sizing, drying, or other preparation. Additives may be incorporated at or on feedstock supply facilities, transport trucks, unloading equipment, storage bins, conveyors (including open or closed conveyors), dryers, process heaters, or any other units. Additives may be added anywhere into the pyrolysis process itself, using suitable means for introducing additives. Additives may be added after carbonization, or even after pulverization, if desired.

In some embodiments, an additive is selected from a metal, a metal oxide, a metal hydroxide, or a combination thereof. For example an additive may be selected from, but is by no means limited to, magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof.

In some embodiments, an additive is selected from an acid, a base, or a salt thereof. For example, an additive may be selected from, but is by no means limited to, sodium hydroxide, potassium hydroxide, magnesium oxide, hydrogen bromide, hydrogen chloride, sodium silicate, potassium permanganate, or combinations thereof.

In some embodiments, an additive is selected from a metal halide. Metal halides are compounds between metals and halogens (fluorine, chlorine, bromine, iodine, and astatine). The halogens can form many compounds with metals. Metal halides are generally obtained by direct combination, or more commonly, neutralization of basic metal salt with a hydrohalic acid. In some embodiments, an additive is selected from iron chloride (FeCl₂ and/or FeCl₃), iron bromide (FeBr₂ and/or FeBr₃), or hydrates thereof, and any combinations thereof.

Additives may result in a final product with higher energy content (energy density). An increase in energy content may result from an increase in total carbon, fixed carbon, volatile carbon, or even hydrogen. Alternatively or additionally, the increase in energy content may result from removal of non-combustible matter or of material having lower energy density than carbon. In some embodiments, additives reduce the extent of liquid formation, in favor of solid and gas formation, or in favor of solid formation.

Without being limited to any particular hypothesis, additives may chemically modify the starting biomass, or treated biomass prior to pyrolysis, to reduce rupture of cell walls for greater strength/integrity. In some embodiments, additives may increase fixed carbon content of biomass feedstock prior to pyrolysis.

Additives may result in a biogenic reagent with improved mechanical properties, such as yield strength, compressive strength, tensile strength, fatigue strength, impact strength, clastic modulus, bulk modulus, or shear modulus. Additives may improve mechanical properties by simply being present (e.g., the additive itself imparts strength to the mixture) or due to some transformation that takes place within the additive phase or within the resulting mixture. For example, reactions such as vitrification may occur within a portion of the biogenic reagent that includes the additive, thereby improving the final strength.

Chemical additives may be applied to wet or dry biomass feedstocks. The additives may be applied as a solid powder, a spray, a mist, a liquid, or a vapor. In some embodiments, additives may be introduced through spraying of a liquid solution (such as an aqueous solution or in a solvent), or by soaking in tanks, bins, bags, or other containers.

In certain embodiments, dip pretreatment is employed wherein the solid feedstock is dipped into a bath comprising the additive, either batchwise or continuously, for a time sufficient to allow penetration of the additive into the solid feed material.

In some embodiments, additives applied to the feedstock may reduce energy requirements for the pyrolysis, and/or increase the yield of the carbonaceous product. In these or other embodiments, additives applied to the feedstock may provide functionality that is desired for the intended use of the carbonaceous product.

The throughput, or process capacity, may vary widely from small laboratory-scale units to full operations, including any pilot, demonstration, or semi-commercial scale. In various embodiments, the process capacity (for feedstocks, products, or both) is at least about 1 kg/day, 10 kg/day, 100 kg/day, 1 ton/day (all tons are metric tons), 10 tons/day, 100 tons/day, 500 tons/day, 1000 tons/day, 2000 tons/day, or higher.

In some embodiments, a portion of solids produced may be recycled to the front end of the process, i.e. to the drying or deaeration unit or directly to the reactor. By returning to the front end and passing through the process again, treated solids may become higher in fixed carbon. Solid, liquid, and gas streams produced or existing within the process can be independently recycled, passed to subsequent steps, or removed/purged from the process at any point.

In some embodiments, pyrolyzed material is recovered and then fed to a separate unit for further pyrolysis, to create a product with higher carbon purity (e.g., conversion of low-fixed-carbon material to high-fixed-carbon material). In some embodiments, the secondary process may be conducted in a simple container, such as a steel drum, in which heated inert gas (such as heated N₂) is passed through. Other containers useful for this purpose include process tanks, barrels, bins, totes, sacks, and roll-offs. This secondary sweep gas with volatiles may be sent to the thermal oxidizer, or back to the main process reactor, for example. To cool the final product, another stream of inert gas, which is initially at ambient temperature for example, may be passed through the solids to cool the solids, and then returned to an inert gas preheat system.

Some variations of the invention utilize a biogenic reagent production system comprising:
(a) a feeder configured to introduce a carbon-containing feedstock;
(b) an optional dryer, disposed in operable communication with the feeder, configured to remove moisture contained within a carbon-containing feedstock;
(c) a multiple-zone reactor, disposed in operable communication with the dryer, wherein the multiple-zone reactor contains at least a pyrolysis zone disposed in operable communication with a spatially separated cooling zone, and wherein the multiple-zone reactor is configured with an outlet to remove condensable vapors and non-condensable gases from solids;
(d) a solids cooler, disposed in operable communication with the multiple-zone reactor; and
(e) a biogenic reagent recovery unit, disposed in operable communication with the solids cooler.

Some variations utilize a biogenic reagent production system comprising:
(a) a feeder configured to introduce a carbon-containing feedstock;
(b) an optional dryer, disposed in operable communication with the feeder, configured to remove moisture contained within a carbon-containing feedstock;
(c) an optional preheater, disposed in operable communication with the dryer, configured to heat and/or mildly pyrolyze the feedstock;
(d) a pyrolysis reactor, disposed in operable communication with the preheater, configured to pyrolyze the feedstock;
(e) a cooler, disposed in operable communication with the pyrolysis reactor, configured to cool pyrolyzed solids; and
(f) a biogenic reagent recovery unit, disposed in operable communication with the cooler,
wherein the system is configured with at least one gas outlet to remove condensable vapors and non-condensable gases from solids.

The feeder may be physically integrated with the multiple-zone reactor, such as through the use of a screw feeder or auger mechanism to introduce feed solids into the first reaction zone.

In some embodiments, the system further comprises a preheating zone, disposed in operable communication with the pyrolysis zone. Each of the pyrolysis zone, cooling zone, and preheating zone (if present) may be located within a single unit, or may be located in separate units.

Optionally, the dryer may be configured as a drying zone within the multiple-zone reactor. Optionally, the solids cooler may be disposed within the multiple-zone reactor (i.e., configured as an additional cooling zone or integrated with the main cooling zone).

The system may include a purging means for removing oxygen from the system. For example, the purging means may comprise one or more inlets to introduce a substantially inert gas, and one or more outlets to remove the substantially inert gas and displaced oxygen from the system. In some embodiments, the purging means is a deaerator disposed in operable communication between the dryer and the multiple-zone reactor.

The multiple-zone reactor is preferably configured with at least a first gas inlet and a first gas outlet. The first gas inlet and the first gas outlet may be disposed in communication with different zones, or with the same zone.

In some embodiments, the multiple-zone reactor is configured with a second gas inlet and/or a second gas outlet. In some embodiments, the multiple-zone reactor is configured with a third gas inlet and/or a third gas outlet. In some embodiments, the multiple-zone reactor is configured with a fourth gas inlet and/or a fourth gas outlet. In some embodiments, each zone present in the multiple-zone reactor is configured with a gas inlet and a gas outlet.

Gas inlets and outlets allow not only introduction and withdrawal of vapor, but gas outlets (probes) in particular allow precise process monitoring and control across various stages of the process, up to and potentially including all stages of the process. Precise process monitoring would be expected to result in yield and efficiency improvements, both dynamically as well as over a period of time when operational history can be utilized to adjust process conditions.

In preferred embodiments, a reaction gas probe is disposed in operable communication with the pyrolysis zone. Such a reaction gas probe may be useful to extract gases and analyze them, in order to determine extent of reaction, pyrolysis selectivity, or other process monitoring. Then, based on the measurement, the process may be controlled or adjusted in any number of ways, such as by adjusting feed rate, rate of inert gas sweep, temperature (of one or more zones), pressure (of one or more zones), additives, and so on.

As intended herein, “monitor and control” via reaction gas probes should be construed to include any one or more sample extractions via reaction gas probes, and optionally making process or equipment adjustments based on the measurements, if deemed necessary or desirable, using well-known principles of process control (feedback, feedforward, proportional-integral-derivative logic, etc.).

A reaction gas probe may be configured to withdraw gas samples in a number of ways. For example, a sampling line may have a lower pressure than the pyrolysis reactor pressure, so that when the sampling line is opened an amount of gas can readily be withdrawn from pyrolysis zone. The sampling line may be under vacuum, such as when the pyrolysis zone is near atmospheric pressure. Typically, a reaction gas probe will be associated with one gas output, or a portion thereof (e.g., a line split from a gas output line).

In some embodiments, both a gas input and a gas output are utilized as a reaction gas probe by periodically introducing an inert gas into a zone, and pulling the inert gas with a process sample out of the gas output (“sample sweep”). Such an arrangement could be used in a zone that does not otherwise have a gas inlet/outlet for the substantially inert gas for processing, or, the reaction gas probe could be associated with a separate gas inlet/outlet that is in addition to process inlets and outlets. A sampling inert gas that is introduced and withdrawn periodically for sampling (in embodiments that utilize sample sweeps) could even be different than the process inert gas, if desired, either for reasons of accuracy in analysis or to introduce an analytical tracer.

For example, acetic acid concentration in the gas phase of the pyrolysis zone may be measured using a gas probe to extract a sample, which is then analyzed using a suitable technique (such as gas chromatography, GC; mass spectroscopy, MS; GC-MS, or Fourier-Transform Infrared Spectroscopy, FTIR). CO and/or CO₂ concentration in the gas phase could be measured and used as an indication of the pyrolysis selectivity toward gases/vapors, for example. Terpene concentration in the gas phase could be measured and used as an indication of the pyrolysis selectivity toward liquids, for example.

In some embodiments, the system further comprises at least one additional gas probe disposed in operable communication with the cooling zone, or with the drying zone (if present) or the preheating zone (if present).

A gas probe for the cooling zone could be useful to determine the extent of any additional chemistry taking place in the cooling zone, for example. A gas probe in the cooling zone could also be useful as an independent measurement of temperature (in addition, for example, to a thermocouple disposed in the cooling zone). This independent measurement may be a correlation of cooling temperature with a measured amount of a certain species. The correlation could be separately developed, or could be established after some period of process operation.

A gas probe for the drying zone could be useful to determine the extent of drying, by measuring water content, for example. A gas probe in the preheating zone could be useful to determine the extent of any mild pyrolysis taking place, for example.

In certain embodiments, the cooling zone is configured with a gas inlet, and the pyrolysis zone is configured with a gas outlet, to generate substantially countercurrent flow of the gas phase relative to the solid phase. Alternatively, or additionally, the preheating zone (when it is present) may be configured with a gas outlet, to generate substantially countercurrent flow of the gas phase relative to the solid phase. Alternatively, or additionally, the drying zone may be configured with a gas outlet, to generate substantially countercurrent flow.

The pyrolysis reactor or reactors may be selected from any suitable reactor configuration that is capable of carrying out the pyrolysis process. Exemplary reactor configurations include, but are not limited to, fixed-bed reactors, fluidized-bed reactors, entrained-flow reactors, augers, ablative reactors, rotating cones, rotary drum kilns, calciners, roasters, moving-bed reactors, transport-bed reactors, ablative reactors, rotating cones, or microwave-assisted pyrolysis reactors.

In some embodiments in which an auger is used, sand or another heat carrier can optionally be employed. For example, the feedstock and sand can be fed at one end of a screw. The screw mixes the sand and feedstock and conveys them through the reactor. The screw can provide good control of the feedstock residence time and does not dilute the pyrolyzed products with a carrier or fluidizing gas. The sand can be reheated in a separate vessel.

In some embodiments in which an ablative process is used, the feedstock is moved at a high speed against a hot metal surface. Ablation of any char forming at surfaces can maintain a high rate of heat transfer. Such apparatus can prevent dilution of products. As an alternative, the feedstock particles may be suspended in a carrier gas and introduced at a high speed through a cyclone whose wall is heated.

In some embodiments in which a fluidized-bed reactor is used, the feedstock can be introduced into a bed of hot sand fluidized by a gas, which is typically a recirculated product gas. Reference herein to “sand” shall also include similar, substantially inert materials, such as glass particles, recovered ash particles, and the like. High heat-transfer rates from fluidized sand can result in rapid heating of the feedstock. There can be some ablation by attrition with the sand particles. Heat is usually provided by heat-exchanger tubes through which hot combustion gas flows.

Circulating fluidized-bed reactors can be employed, wherein gas, sand, and feedstock move together. Exemplary transport gases include recirculated product gases and combustion gases. High heat-transfer rates from the sand ensure rapid heating of the feedstock, and ablation is expected to be stronger than with regular fluidized beds. A separator can be employed to separate the product gases from the sand and char particles. The sand particles can be reheated in a fluidized burner vessel and recycled to the reactor.

In some embodiments, a multiple-zone reactor is a continuous reactor comprising a feedstock inlet, a plurality of spatially separated reaction zones configured for separately controlling the temperature and mixing within each of the reaction zones, and a carbonaceous-solids outlet, wherein one of the reaction zones is configured with a first gas inlet for introducing a substantially inert gas into the reactor, and wherein one of the reaction zones is configured with a first gas outlet.

In various embodiments the reactor includes at least two, three, four, or more reaction zones. Each of the reaction zones is disposed in communication with separately adjustable heating means independently selected from electrical heat transfer, steam heat transfer, hot-oil heat transfer, phase-change heat transfer, waste heat transfer, or a combination thereof. In some embodiments, at least one reactor zone is heated with an effluent stream from the thermal oxidizer, if present.

The reactor may be configured for separately adjusting gas-phase composition and gas-phase residence time of at least two reaction zones, up to and including all reaction zones present in the reactor.

The reactor may be equipped with a second gas inlet and/or a second gas outlet. In some embodiments, the reactor is configured with a gas inlet in each reaction zone. In these or other embodiments, the reactor is configured with a gas outlet in each reaction zone. The reactor may be a co-current or countercurrent reactor.

In some embodiments, the feedstock inlet comprises a screw or auger feed mechanism. In some embodiments, the carbonaceous-solids outlet comprises a screw or auger output mechanism.

Certain embodiments utilize a rotating calciner with a screw feeder. In these embodiments, the reactor is axially rotatable, i.e. it spins about its centerline axis. The speed of rotation will impact the solid flow pattern, and heat and mass transport. Each of the reaction zones may be configured with flights disposed on internal walls, to provide agitation of solids. The flights may be separately adjustable in each of the reaction zones.

Other means of agitating solids may be employed, such as augers, screws, or paddle conveyors. In some embodiments, the reactor includes a single, continuous auger disposed throughout each of the reaction zones. In other embodiments, the reactor includes twin screws disposed throughout each of the reaction zones.

Some systems are designed specifically with the capability to maintain the approximate size of feed material throughout the process—that is, to process the biomass feedstock without destroying or significantly damaging its structure. In some embodiments, the pyrolysis zone does not contain augers, screws, or rakes that would tend to greatly reduce the size of feed material being pyrolyzed.

In some embodiments of the invention, the system further includes a thermal oxidizer disposed in operable communication with the outlet at which condensable vapors and non-condensable gases are removed. The thermal oxidizer is preferably configured to receive a separate fuel (such as natural gas) and an oxidant (such as air) into a combustion chamber, adapted for combustion of the fuel and at least a portion of the condensable vapors. Certain non-condensable gases may also be oxidized, such as CO or CH₄, to CO₂.

When a thermal oxidizer is employed, the system may include a heat exchanger disposed between the thermal oxidizer and the dryer, configured to utilize at least some of the heat of the combustion for the dryer. This embodiment can contribute significantly to the overall energy efficiency of the process.

In some embodiments, the system further comprises a carbon-enhancement unit, disposed in operable communication with the solids cooler, configured for combining condensable vapors, in at least partially condensed form, with the solids. The carbon-enhancement unit may increase the carbon content of the biogenic reagent obtained from the recovery unit.

The system may further include a separate pyrolysis unit adapted to further pyrolyze the biogenic reagent to further increase its carbon content. The separate pyrolysis unit may be a relatively simply container, unit, or device, such as a tank, barrel, bin, drum, tote, sack, or roll-off.

The overall system may be at a fixed location, or it may be distributed at several locations. The system may be constructed using modules which may be simply duplicated for practical scale-up. The system may also be constructed using economy-of-scale principles, as is well-known in the process industries.

Some variations relating to carbon enhancement of solids will now be further described. In some embodiments, a process for producing a biogenic reagent comprises:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) in a pyrolysis zone, pyrolyzing the feedstock in the presence of a substantially inert gas for at least 10 minutes and with a pyrolysis temperature selected from about 250° C. to about 700° C., to generate hot pyrolyzed solids, condensable vapors, and non-condensable gases;
(e) separating at least a portion of the condensable vapors and at least a portion of the non-condensable gases from the hot pyrolyzed solids;
(f) in a cooling zone, cooling the hot pyrolyzed solids, in the presence of the substantially inert gas for at least 5 minutes and with a cooling temperature less than the pyrolysis temperature, to generate warm pyrolyzed solids;
(g) optionally cooling the warm pyrolyzed solids to generate cool pyrolyzed solids;
(h) subsequently passing at least a portion of the condensable vapors and/or at least a portion of the non-condensable gases from step (e) across the warm pyrolyzed solids and/or the cool pyrolyzed solids, to form enhanced pyrolyzed solids with increased carbon content; and
(i) recovering a biogenic reagent comprising at least a portion of the enhanced pyrolyzed solids.

In some embodiments, step (h) includes passing at least a portion of the condensable vapors from step (e), in vapor and/or condensed form, across the warm pyrolyzed solids, to produce enhanced pyrolyzed solids with increased carbon content. In some embodiments, step (h) includes passing at least a portion of the non-condensable gases from step (e) across the warm pyrolyzed solids, to produce enhanced pyrolyzed solids with increased carbon content.

Alternatively, or additionally, vapors or gases may be contacted with the cool pyrolyzed solids. In some embodiments, step (h) includes passing at least a portion of the condensable vapors from step (e), in vapor and/or condensed form, across the cool pyrolyzed solids, to produce enhanced pyrolyzed solids with increased carbon content. In some embodiments, step (h) includes passing at least a portion of the non-condensable gases from step (e) across the cool pyrolyzed solids, to produce enhanced pyrolyzed solids with increased carbon content.

In certain embodiments, step (h) includes passing substantially all of the condensable vapors from step (e), in vapor and/or condensed form, across the cool pyrolyzed solids, to produce enhanced pyrolyzed solids with increased carbon content. In certain embodiments, step (h) includes passing substantially all of the non-condensable gases from step (e) across the cool pyrolyzed solids, to produce enhanced pyrolyzed solids with increased carbon content.

The process may include various methods of treating or separating the vapors or gases prior to using them for carbon enhancement. For example, an intermediate feed stream consisting of at least a portion of the condensable vapors and at least a portion of the non-condensable gases, obtained from step (e), may be fed to a separation unit configured to generate at least first and second output streams. In certain embodiments, the intermediate feed stream comprises all of the condensable vapors, all of the non-condensable gases, or both. Separation techniques can include or use distillation columns, flash vessels, centrifuges, cyclones, membranes, filters, packed beds, capillary columns, and so on. Separation can be principally based, for example, on distillation, absorption, adsorption, or diffusion, and can utilize differences in vapor pressure, activity, molecular weight, density, viscosity, polarity, chemical functionality, affinity to a stationary phase, and any combinations thereof.

In some embodiments, the first and second output streams are separated from the intermediate feed stream based on relative volatility. For example, the separation unit may be a distillation column, a flash tank, or a condenser.

Thus in some embodiments, the first output stream comprises the condensable vapors, and the second output stream comprises the non-condensable gases. The condensable vapors may include at least one carbon-containing compound selected from terpenes, alcohols, acids, aldehydes, or ketones. The vapors from pyrolysis may include aromatic compounds such as benzene, toluene, ethylbenzene, and xylenes. Heavier aromatic compounds, such as refractory tars, may be present in the vapor. The non-condensable gases may include at least one carbon-containing molecule selected from carbon monoxide, carbon dioxide, and methane.

In some embodiments, the first and second output streams are separated intermediate feed stream based on relative polarity. For example, the separation unit may be a stripping column, a packed bed, a chromatography column, or membranes.

Thus in some embodiments, the first output stream comprises polar compounds, and the second output stream comprises non-polar compounds. The polar compounds may include at least one carbon-containing molecule selected from methanol, furfural, or acetic acid. The non-polar compounds may include at least one carbon-containing molecule selected from carbon monoxide, carbon dioxide, methane, a terpene, or a terpene derivative.

Step (h) may increase the total carbon content of the biogenic reagent, relative to an otherwise-identical process without step (h). The extent of increase in carbon content may be, for example, about 1%, 2%, 5%, 10%, 15%, 25%, or even higher, in various embodiments.

In some embodiments, step (h) increases the fixed carbon content of the biogenic reagent. In these or other embodiments, step (h) increases the volatile carbon content of the biogenic reagent. Volatile carbon content is the carbon attributed to volatile matter in the reagent. The volatile matter may be, but is not limited to, hydrocarbons including aliphatic or aromatic compounds (e.g., terpenes); oxygenates including alcohols, aldehydes, or ketones; and various tars. Volatile carbon will typically remain bound or adsorbed to the solids at ambient conditions but upon heating, will be released before the fixed carbon would be oxidized, gasified, or otherwise released as a vapor.

Depending on conditions associated with step (h), it is possible for some amount of volatile carbon to become fixed carbon (e.g., via Boudouard carbon formation from CO). Typically, the volatile matter will enter the micropores of the fixed carbon and will be present as condensed/adsorbed species, but remain relatively volatile. This residual volatility can be more advantageous for fuel applications, compared to product applications requiring high surface area and porosity.

Step (h) may increase the energy content (i.e., energy density) of the biogenic reagent. The increase in energy content may result from an increase in total carbon, fixed carbon, volatile carbon, or even hydrogen. The extent of increase in energy content may be, for example, about 1%, 2%, 5%, 10%, 15%, 25%, or even higher, in various embodiments.

Further separations may be employed to recover one or more non-condensable gases or condensable vapors, for use within the process or further processing. For example, further processing may be included to produce refined carbon monoxide and/or hydrogen.

As another example, separation of acetic acid may be conducted, followed by reduction of the acetic acid into ethanol. The reduction of the acetic acid may be accomplished, at least in part, using hydrogen derived from the non-condensable gases produced.

Condensable vapors may be used for either energy in the process (such as by thermal oxidation) or in carbon enrichment, to increase the carbon content of the biogenic reagent. Certain non-condensable gases, such as CO or CH₄, may be utilized either for energy in the process, or as part of the substantially inert gas for the pyrolysis step. Combinations of any of the foregoing are also possible.

A potential benefit of including step (h) is that the gas stream is scrubbed, with the resulting gas stream being enriched in CO and CO₂. The resulting gas stream may be utilized for energy recovery, recycled for carbon enrichment of solids, and/or used as an inert gas in the reactor. Similarly, by separating non-condensable gases from condensable vapors, the CO/CO₂ stream is prepared for use as the inert gas in the reactor system or in the cooling system, for example.

Other variations are premised on the realization that the principles of the carbon-enhancement step may be applied to any feedstock in which it is desired to add carbon.

In some embodiments, a batch or continuous process for producing a biogenic reagent comprises:
(a) providing a solid stream comprising a carbon-containing material;
(b) providing a gas stream comprising condensable carbon-containing vapors, non-condensable carbon-containing gases, or a mixture of condensable carbon-containing vapors and non-condensable carbon-containing gases; and
(c) passing the gas stream across the solid stream under suitable conditions to form a carbon-containing product with increased carbon content relative to the carbon-containing material.

In some embodiments, the starting carbon-containing material is pyrolyzed biomass or torrefied biomass. The gas stream may be obtained during an integrated process that provides the carbon-containing material. Or, the gas stream may be obtained from separate processing of the carbon-containing material. The gas stream, or a portion thereof, may be obtained from an external source (e.g., an oven at a lumber mill). Mixtures of gas streams, as well as mixtures of carbon-containing materials, from a variety of sources, are possible.

In some embodiments, the process further comprises recycling or reusing the gas stream for repeating the process to further increase carbon and/or energy content of the carbon-containing product. In some embodiments, the process further comprises recycling or reusing the gas stream for carrying out the process to increase carbon and/or energy content of another feedstock different from the carbon-containing material.

In some embodiments, the process further includes introducing the gas stream to a separation unit configured to generate at least first and second output streams, wherein the gas stream comprises a mixture of condensable carbon-containing vapors and non-condensable carbon-containing gases. The first and second output streams may be separated based on relative volatility, relative polarity, or any other property. The gas stream may be obtained from separate processing of the carbon-containing material.

In some embodiments, the process further comprises recycling or reusing the gas stream for repeating the process to further increase carbon content of the carbon-containing product. In some embodiments, the process further comprises recycling or reusing the gas stream for carrying out the process to increase carbon content of another feedstock.

The carbon-containing product may have an increased total carbon content, a higher fixed carbon content, a higher volatile carbon content, a higher energy content, or any combination thereof, relative to the starting carbon-containing material.

In related variations, a biogenic reagent production system comprises:
(a) a feeder configured to introduce a carbon-containing feedstock;
(b) an optional dryer, disposed in operable communication with the feeder, configured to remove moisture contained within a carbon-containing feedstock;
(c) a multiple-zone reactor, disposed in operable communication with the dryer, wherein the multiple-zone reactor contains at least a pyrolysis zone disposed in operable communication with a spatially separated cooling zone, and wherein the multiple-zone reactor is configured with an outlet to remove condensable vapors and non-condensable gases from solids;
(d) a solids cooler, disposed in operable communication with the multiple-zone reactor;
(e) a material-enrichment unit, disposed in operable communication with the solids cooler, configured to pass the condensable vapors and/or the non-condensable gases across the solids, to form enhanced solids with increased carbon content; and
(f) a biogenic reagent recovery unit, disposed in operable communication with the material-enrichment unit.

The system may further comprise a preheating zone, disposed in operable communication with the pyrolysis zone. In some embodiments, the dryer is configured as a drying zone within the multiple-zone reactor. Each of the zones may be located within a single unit or in separate units. Also, the solids cooler may be disposed within the multiple-zone reactor.

In some embodiments, the cooling zone is configured with a gas inlet, and the pyrolysis zone is configured with a gas outlet, to generate substantially countercurrent flow of the gas phase relative to the solid phase. In these or other embodiments, the preheating zone and/or the drying zone (or dryer) is configured with a gas outlet, to generate substantially countercurrent flow of the gas phase relative to the solid phase.

In particular embodiments, the system incorporates a material-enrichment unit that comprises:
(i) a housing with an upper portion and a lower portion;
(ii) an inlet at a bottom of the lower portion of the housing configured to carry the condensable vapors and non-condensable gases;
(iii) an outlet at a top of the upper portion of the housing configured to carry a concentrated gas stream derived from the condensable vapors and non-condensable gases;
(iv) a path defined between the upper portion and the lower portion of the housing; and (v) a transport system following the path, the transport system configured to transport the solids, wherein the housing is shaped such that the solids adsorb at least some of the condensable vapors and/or at least some of the non-condensable gases.

The present invention is capable of producing a variety of compositions useful as biogenic reagents, and products incorporating such reagents. In some variations, a biogenic reagent is produced by any process disclosed herein, such as a process comprising the steps of:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) in a pyrolysis zone, pyrolyzing the feedstock in the presence of a substantially inert gas for at least 10 minutes and with a pyrolysis temperature selected from about 250° C. to about 700° C., to generate hot pyrolyzed solids, condensable vapors, and non-condensable gases;
(e) separating at least a portion of the condensable vapors and at least a portion of the non-condensable gases from the hot pyrolyzed solids;
(f) in a cooling zone, cooling the hot pyrolyzed solids, in the presence of the substantially inert gas for at least 5 minutes and with a cooling temperature less than the pyrolysis temperature, to generate warm pyrolyzed solids;
(g) cooling the warm pyrolyzed solids to generate cool pyrolyzed solids; and
(h) recovering a biogenic reagent comprising at least a portion of the cool pyrolyzed solids.

In some embodiments, the reagent comprises about at least 70 wt %, at least 80 wt %, at least 90 wt %, or at least 95 wt % total carbon on a dry basis. The total carbon includes at least fixed carbon, and may further include carbon from volatile matter. In some embodiments, carbon from volatile matter is about at least 5%, at least 10%, at least 25%, or at least 50% of the total carbon present in the biogenic reagent. Fixed carbon may be measured using ASTM D3172, while volatile carbon may be measured using ASTM D3175, for example.

The biogenic reagent may comprise about 10 wt % or less, such as about 5 wt % or less, hydrogen on a dry basis. The biogenic reagent may comprise about 1 wt % or less, such as about 0.5 wt % or less, nitrogen on a dry basis. The biogenic reagent may comprise about 0.5 wt % or less, such as about 0.2 wt % or less, phosphorus on a dry basis. The biogenic reagent may comprise about 0.2 wt % or less, such as about 0.1 wt % or less, sulfur on a dry basis.

Carbon, hydrogen, and nitrogen may be measured using ASTM D5373 for ultimate analysis, for example. Oxygen may be measured using ASTM D3176, for example. Sulfur may be measured using ASTM D3177, for example.

Certain embodiments provide reagents with little or essentially no hydrogen (except from any moisture that may be present), nitrogen, phosphorus, or sulfur, and are substantially carbon plus any ash and moisture present. Therefore, some embodiments provide a biogenic reagent with up to and including 100% carbon, on a dry/ash-free (DAF) basis.

Generally speaking, feedstocks such as biomass contain non-volatile species, including silica and various metals, which are not readily released during pyrolysis. It is of course possible to utilize ash-free feedstocks, in which case there should not be substantial quantities of ash in the pyrolyzed solids. Ash may be measured using ASTM D3174, for example.

Various amounts of non-combustible matter, such as ash, may be present. The biogenic reagent may comprise about 10 wt % or less, such as about 5 wt %, about 2 wt %, about 1 wt % or less non-combustible matter on a dry basis. In certain embodiments, the reagent contains little ash, or even essentially no ash or other non-combustible matter. Therefore, some embodiments provide essentially pure carbon, including 100% carbon, on a dry basis.

Various amounts of moisture may be present. On a total mass basis, the biogenic reagent may comprise at least 1 wt %, 2 wt %, 5 wt %, 10 wt %, 15 wt %, 25 wt %, 35 wt %, 50 wt %, or more moisture. As intended herein, “moisture” is to be construed as including any form of water present in the biogenic reagent, including absorbed moisture, adsorbed water molecules, chemical hydrates, and physical hydrates. The equilibrium moisture content may vary at least with the local environment, such as the relative humidity. Also, moisture may vary during transportation, preparation for use, and other logistics. Moisture may be measured using ASTM D3173, for example.

The biogenic reagent may have various energy contents which for present purposes means the energy density based on the higher heating value associated with total combustion of the bone-dry reagent. For example, the biogenic reagent may possess an energy content of about at least 11,000 Btu/lb, at least 12,000 Btu/lb, at least 13,000 Btu/lb, at least 14,000 Btu/lb, or at least 15,000 Btu/lb. In certain embodiments, the energy content is between about 14,000-15,000 Btu/lb. The energy content may be measured using ASTM D5865, for example.

The biogenic reagent may be formed into a powder, such as a coarse powder or a fine powder. For example, the reagent may be formed into a powder with an average mesh size of about 200 mesh, about 100 mesh, about 50 mesh, about 10 mesh, about 6 mesh, about 4 mesh, or about 2 mesh, in embodiments.

In some embodiments, the biogenic reagent is formed into structural objects comprising pressed, binded, or agglomerated particles. The starting material to form these objects may be a powder form of the reagent, such as an intermediate obtained by particle-size reduction. The objects may be formed by mechanical pressing or other forces, optionally with a binder or other means of agglomerating particles together.

In some embodiments, the biogenic reagent is produced in the form of structural objects whose structure substantially derives from the feedstock. For example, feedstock chips may produce product chips of biogenic reagent. Or, feedstock cylinders may produce biogenic reagent cylinders, which may be somewhat smaller but otherwise maintain the basic structure and geometry of the starting material.

A biogenic reagent according to the present invention may be produced as, or formed into, an object that has a minimum dimension of at least about 1 cm, 2 cm, 3 cm, 4 cm, 5 cm, 6 cm, 7 cm, 8 cm, 9 cm, 10 cm, or higher. In various embodiments, the minimum dimension or maximum dimension can be a length, width, or diameter.

Other variations of the invention relate to the incorporation of additives into the process, into the product, or both. In some embodiments, the biogenic reagent includes at least one process additive incorporated during the process. In these or other embodiments, the reagent includes at least one product additive introduced to the reagent following the process.

In some embodiments, a biogenic reagent comprises, on a dry basis:
70 wt % or more total carbon;
5 wt % or less hydrogen;
1 wt % or less nitrogen;
0.5 wt % or less phosphorus;
0.2 wt % or less sulfur; and an additive selected from a metal, a metal oxide, a metal hydroxide, a metal halide, or a combination thereof.

The additive may be selected from, but is by no means limited to, magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof.

In some embodiments, a biogenic reagent comprises, on a dry basis:
70 wt % or more total carbon;
5 wt % or less hydrogen;
1 wt % or less nitrogen;
0.5 wt % or less phosphorus;
0.2 wt % or less sulfur; and an additive selected from an acid, a base, or a salt thereof.

The additive may be selected from, but is by no means limited to, sodium hydroxide, potassium hydroxide, magnesium oxide, hydrogen bromide, hydrogen chloride, sodium silicate, potassium permanganate, or combinations thereof.

In certain embodiments, a biogenic reagent comprises, on a dry basis:
70 wt % or more total carbon;
5 wt % or less hydrogen;
1 wt % or less nitrogen;
0.5 wt % or less phosphorus;
0.2 wt % or less sulfur;
a first additive selected from a metal, metal oxide, metal hydroxide, a metal halide, or a combination thereof; and
a second additive selected from an acid, a base, or a salt thereof,
wherein the first additive is different from the second additive.

The first additive may be selected from magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof, while the second additive may be independently selected from sodium hydroxide, potassium hydroxide, magnesium oxide, hydrogen bromide, hydrogen chloride, sodium silicate, potassium permanganate, or combinations thereof.

A certain biogenic reagent consists essentially of, on a dry basis, carbon, hydrogen, nitrogen, phosphorus, sulfur, non-combustible matter, and an additive selected from magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, or a combination thereof.

A certain biogenic reagent consists essentially of, on a dry basis, carbon, hydrogen, nitrogen, phosphorus, sulfur, non-combustible matter, and an additive selected from sodium hydroxide, potassium hydroxide, magnesium oxide, hydrogen bromide, hydrogen chloride, sodium silicate, or a combination thereof.

The amount of additive (or total additives) may vary widely, such as from about 0.01 wt % to about 25 wt %, including about 0.1 wt %, about 1 wt %, about 5 wt %, about 10 wt %, or about 20 wt %. It will be appreciated then when relatively large amounts of additives are incorporated, such as higher than about 1 wt %, there will be a reduction in energy content calculated on the basis of the total reagent weight (inclusive of additives). Still, in various embodiments, the biogenic reagent with additive(s) may possess an energy content of about at least 11,000 Btu/lb, at least 12,000 Btu/lb, at least 13,000 Btu/lb, at least 14,000 Btu/lb, or at least 15,000 Btu/lb.

The above discussion regarding product form applies also to embodiments that incorporate additives. In fact, certain embodiments incorporate additives as binding agents, fluxing agents, or other modifiers to enhance final properties for a particular application.

In preferred embodiments, the majority of carbon contained in the biogenic reagent is classified as renewable carbon. In some embodiments, substantially all of the carbon is classified as renewable carbon. There may be certain market mechanisms (e.g., Renewable Identification Numbers, tax credits, etc.) wherein value is attributed to the renewable carbon content within the biogenic reagent.

In certain embodiments, the fixed carbon may be non-renewable carbon (e.g., from coal) while the volatile carbon, which may be added separately, may be renewable carbon to increase not only energy content but also renewable carbon value.

The biogenic reagents produced as described herein is useful for a wide variety of carbonaceous products. The biogenic reagent may be a desirable market product itself. Biogenic reagents as provided herein are associated with lower levels of impurities, reduced process emissions, and improved sustainability (including higher renewable carbon content) compared to the state of the art.

In variations, a product includes any of the biogenic reagents that may be obtained by the disclosed processes, or that are described in the compositions set forth herein, or any portions, combinations, or derivatives thereof.

Generally speaking, the biogenic reagents may be combusted to produce energy (including electricity and heat); partially oxidized, gasified, or steam-reformed to produce syngas; utilized for their adsorptive or absorptive properties; utilized for their reactive properties during metal refining (such as reduction of metal oxides) or other industrial processing; or utilized for their material properties in carbon steel and various other metal alloys. Essentially, the biogenic reagents may be utilized for any market application of carbon-based commodities or advanced materials, including specialty uses to be developed.

Prior to suitability or actual use in any product applications, the disclosed biogenic reagents may be analyzed, measured, and optionally modified (such as through additives) in various ways. Some properties of potential interest, other than chemical composition and energy content, include density, particle size, surface area, microporosity, absorptivity, adsorptivity, binding capacity, reactivity, desulfurization activity, and basicity, to name a few properties.

Products or materials that may incorporate these biogenic reagents include, but are by no means limited to, carbon-based blast furnace addition products, carbon-based taconite pellet addition products, ladle addition carbon-based products, met coke carbon-based products, coal replacement products, carbon-based coking products, carbon breeze products, fluidized-bed carbon-based feedstocks, carbon-based furnace addition products, injectable carbon-based products, pulverized carbon-based products, stoker carbon-based products, carbon electrodes, or activated carbon products.

Use of the disclosed biogenic reagents in metals production can reduce slag, increase overall efficiency, and reduce lifecycle environmental impacts in metal processing and manufacturing.

Some variations of the invention utilize the biogenic reagents as carbon-based blast furnace addition products. A blast furnace is a type of metallurgical furnace used for smelting to produce industrial metals, such as (but not limited to) iron. Smelting is a form of extractive metallurgy; its main use is to produce a metal from its ore. Smelting uses heat and a chemical reducing agent to decompose the ore. The carbon and/or the carbon monoxide derived from the carbon removes oxygen from the ore, leaving behind elemental metal.

The reducing agent may consist of, or comprise, a biogenic reagent. In a blast furnace, biogenic reagent, ore, and typically limestone may be continuously supplied through the top of the furnace, while air (optionally with oxygen enrichment) is blown into the bottom of the chamber, so that the chemical reactions take place throughout the furnace as the material moves downward. The end products are usually molten metal and slag phases tapped from the bottom, and flue gases exiting from the top of the furnace. The downward flow of the ore in contact with an upflow of hot, carbon monoxide-rich gases is a countercurrent process.

Carbon quality in the blast furnace is measured by its resistance to degradation. The role of the carbon as a permeable medium is crucial in economic blast furnace operation. The degradation of the carbon varies with the position in the blast furnace and involves the combination of reaction with CO₂, H₂O, or O₂ and the abrasion of carbon particles against each other and other components of the burden. Degraded carbon particles may cause plugging and poor performance.

The Coke Reactivity test is a highly regarded measure of the performance of carbon in a blast furnace. This test has two components: the Coke Reactivity Index (CRI) and the Coke Strength after Reaction (CSR). A carbon-based material with a low CRI value (high reactivity) and a high CSR value is preferable for better blast furnace performance. CRI can be determined according to any suitable method known in the art, for example by ASTM Method DS341 on an as-received basis.

In some embodiments, the biogenic reagent provides a carbon product having suitable properties for introduction directly into a blast furnace.

The strength of the biogenic reagent may be determined by any suitable method known in the art, for example by a drop-shatter test, or a CSR test. In some embodiments, the biogenic reagent, optionally when blended with another source of carbon, provides a final carbon product having CSR of at least about 50%, 60%, or 70%. A combination product may also provide a final coke product having a suitable reactivity for combustion in a blast furnace. In some embodiments, the product has a CRI such that the biogenic reagent is suitable for use as an additive or replacement for met coal, met coke, coke breeze, foundry coke, or injectable coal.

Some embodiments employ one or more additives in an amount sufficient to provide a biogenic reagent that, when added to another carbon source (e.g., coke) having a CRI or CSR insufficient for use as a blast furnace product, provides a composite product with a CRI and/or CSR sufficient for use in a blast furnace. In some embodiments, one or more additives are present in an amount sufficient to provide a biogenic reagent having a CRI of not more than about 40%, 30%, or 20%.

In some embodiments, one or more additives selected from the alkaline earth metals, or oxides or carbonates thereof, are introduced during or after the process of producing a biogenic reagent. For example, calcium, calcium oxide, calcium carbonate, magnesium oxide, or magnesium carbonate may be introduced as additives. The addition of these compounds before, during, or after pyrolysis may increase the reactivity of the biogenic reagent in a blast furnace. These compounds may lead to stronger materials, i.e. higher CSR, thereby improving blast-furnace efficiency. In addition, additives such as those selected from the alkaline earth metals, or oxides or carbonates thereof, may lead to lower emissions (e.g., SO₂).

In some embodiments, a blast furnace replacement product is a biogenic reagent comprising at least about 55 wt % carbon, not more than about 0.5 wt % sulfur, not more than about 8 wt % non-combustible material, and a heat value of at least about 11,000 Btu per pound. In some embodiments, the blast furnace replacement product further comprises not more than about 0.035 wt % phosphorous, about 0.5 wt % to about 50 wt % volatile matter, and optionally one or more additives. In some embodiments, the blast furnace replacement product comprises about 2 wt % to about 15 wt % dolomite, about 2 wt % to about 15 wt % dolomitic lime, about 2 wt % to about 15 wt % bentonite, and/or about 2 wt % to about 15 wt % calcium oxide. In some embodiments, the blast furnace replacement product has dimensions substantially in the range of about 1 cm to about 10 cm.

In some embodiments, a biogenic reagent is useful as a foundry coke replacement product. Foundry coke is generally characterized as having a carbon content of at least about 85 wt %, a sulfur content of about 0.6 wt %, not more than about 1.5 wt % volatile matter, not more than about 13 wt % ash, not more than about 8 wt % moisture, about 0.035 wt % phosphorus, a CRI value of about 30, and dimensions ranging from about 5 cm to about 25 cm.

Some variations utilize the biogenic reagents as carbon-based taconite pellet addition products. The ores used in making iron and steel are iron oxides. Major iron oxide ores include hematite, limonite (also called brown ore), taconite, and magnetite, a black ore. Taconite is a low-grade but important ore, which contains both magnetite and hematite. The iron content of taconite is generally 25 wt % to 35 wt %. Blast furnaces typically require at least 50 wt % iron content ore for efficient operation. Iron ores may undergo beneficiation including crushing, screening, tumbling, flotation, and magnetic separation. The refined ore is enriched to over 60% iron and is often formed into pellets before shipping. Taconite pellets are usually marble-sized and work very well in blast furnaces.

For example, taconite may be ground into a fine powder and combined with a binder such as bentonite clay and limestone. Pellets about one centimeter in diameter may be formed, containing approximately 65 wt % iron, for example. The pellets are fired, oxidizing magnetite to hematite. The pellets are durable which ensures that the blast furnace charge remains porous enough to allow heated gas to pass through and react with the pelletized ore.

The taconite pellets may be fed to a blast furnace to produce iron, as described above with reference to blast furnace addition products. In some embodiments, a biogenic reagent is introduced to the blast furnace. In these or other embodiments, a biogenic reagent is incorporated into the taconite pellet itself. For example, taconite ore powder, after beneficiation, may be mixed with a biogenic reagent and a binder and rolled into small objects, then baked to hardness. In such embodiments, taconite-carbon pellets with the appropriate composition may conveniently be introduced into a blast furnace without the need for a separate source of carbon.

Some variations utilize the biogenic reagents as ladle addition carbon-based products. A ladle is a vessel used to transport and pour out molten metals. Casting ladles are used to pour molten metal into molds to produce the casting. Transfers ladle are used to transfer a large amount of molten metal from one process to another. Treatment ladles are used for a process to take place within the ladle to change some aspect of the molten metal, such as the conversion of cast iron to ductile iron by the addition of various elements into the ladle.

Biogenic reagents may be introduced to any type of ladle, but typically carbon will be added to treatment ladles in suitable amounts based on the target carbon content. Carbon injected into ladles may be in the form of fine powder, for good mass transport of the carbon into the final composition. In some embodiments, a biogenic reagent, when used as a ladle addition product, has a minimum dimension of about 0.5 cm, such as about 0.75 cm, about 1 cm, about 1.5 cm, or higher.

In some embodiments, a high carbon biogenic reagent is useful as a ladle addition carbon additive at, for example, basic oxygen furnace or electric arc furnace facilities wherever ladle addition of carbon would be used (e.g., added to ladle carbon during steel manufacturing).

In some embodiments, the ladle addition carbon additive additionally comprises up to about 5 wt % manganese, up to about 5 wt % calcium oxide, and/or up to about 5 wt % dolomitic lime.

Direct-reduced iron (DRI), also called sponge iron, is produced from direct reduction of iron ore (in the form of lumps, pellets, or fines) by a reducing gas conventionally produced from natural gas or coal. The reducing gas is typically syngas, a mixture of hydrogen and carbon monoxide which acts as reducing agent. The biogenic reagent as provided herein may be converted into a gas stream comprising CO, to act as a reducing agent to produce direct-reduced iron.

Iron nuggets are a high-quality steelmaking and iron-casting feed material. Iron nuggets are essentially all iron and carbon, with almost no gangue (slag) and low levels of metal residuals. They are a premium grade pig iron product with superior shipping and handling characteristics. The carbon contained in iron nuggets, or any portion thereof, may be the biogenic reagent provided herein. Iron nuggets may be produced through the reduction of iron ore in a rotary hearth furnace, using a biogenic reagent as the reductant and energy source.

Some variations utilize the biogenic reagents as metallurgical coke carbon-based products. Metallurgical coke, also known as “met” coke, is a carbon material normally manufactured by the destructive distillation of various blends of bituminous coal. The final solid is a non-melting carbon called metallurgical coke. As a result of the loss of volatile gases and of partial melting, met coke has an open, porous morphology. Met coke has a very low volatile content. However, the ash constituents, that were part of the original bituminous coal feedstock, remain encapsulated in the resultant coke. Met coke feedstocks are available in a wide range of sizes from fine powder to basketball-sized lumps. Typical purities range from 86-92 wt % fixed carbon.

Metallurgical coke is used where a high-quality, tough, resilient, wearing carbon is required. Applications include, but are not limited to, conductive flooring, friction materials (e.g., carbon linings), foundry coatings, foundry carbon raiser, corrosion materials, drilling applications, reducing agents, heat-treatment agents, ceramic packing media, electrolytic processes, and oxygen exclusion.

Met coke may be characterized as having a heat value of about 10,000 to 14,000 Btu per pound and an ash content of about 10 wt % or greater. Thus, in some embodiments, a met coke replacement product comprises a biogenic reagent according to the present invention comprising at least about 80 wt %, 85 wt %, or 90 wt % carbon, not more than about 0.8 wt % sulfur, not more than about 3 wt % volatile matter, not more than about 15 wt % ash, not more than about 13 wt % moisture, and not more than about 0.035 wt % phosphorus. A biogenic reagent according to the present invention, when used as a met coke replacement product, may have a size range from about 2 cm to about 15 cm, for example.

In some embodiments, the met coke replacement product further comprises an additive such as chromium, nickel, manganese, magnesium oxide, silicon, aluminum, dolomite, fluorospar, calcium oxide, lime, dolomitic lime, bentonite and combinations thereof.

Some variations utilize the biogenic reagents as coal replacement products. Any process or system using coal can in principle be adapted to use a biogenic reagent. In some embodiments, a biogenic reagent is combined with one or more coal-based products to form a composite product having a higher rank than the coal-based product(s) and/or having fewer emissions, when burned, than the pure coal-based product.

For example, a low-rank coal such as sub-bituminous coal may be used in applications normally calling for a higher-rank coal product, such as bituminous coal, by combining a selected amount of a biogenic reagent according to the present invention with the low-rank coal product. In other embodiments, the rank of a mixed coal product (e.g., a combination of a plurality of coals of different rank) may be improved by combining the mixed coal with some amount of biogenic reagent. The amount of a biogenic reagent to be mixed with the coal product(s) may vary depending on the rank of the coal product(s), the characteristics of the biogenic reagent (e.g., carbon content, heat value, etc.) and the desired rank of the final combined product.

For example, anthracite coal is generally characterized as having at least about 80 wt % carbon, about 0.6 wt % sulfur, about 5 wt % volatile matter, up to about 15 wt % ash, up to about 10 wt % moisture, and a heat value of about 12,494 Btu/lb. In some embodiments, an anthracite coal replacement product is a biogenic reagent comprising at least about 80 wt % carbon, not more than about 0.6 wt % sulfur, not more than about 15 wt % ash, and a heat value of at least about 12,000 Btu/lb.

In some embodiments, a biogenic reagent is useful as a thermal coal replacement product. Thermal coal products are generally characterized as having high sulfur levels, high phosphorus levels, high ash content, and heat values of up to about 15,000 Btu/lb. In some embodiments, a thermal coal replacement product is a biogenic reagent comprising not more than about 0.5 wt % sulfur, not more than about 4 wt % ash, and a heat value of at least about 12,000 Btu/lb.

Some variations of the invention utilize the biogenic reagents as carbon-based coking products. Any coking process or system may be adapted to use biogenic reagents to produce coke, or use it as a coke feedstock.

In some embodiments, a biogenic reagent is useful as a thermal coal or coke replacement product. For example, a thermal coal or coke replacement product may consist of a biogenic reagent comprising at least about 50 wt % carbon, not more than about 8 wt % ash, not more than about 0.5 wt % sulfur, and a heat value of at least about 11,000 Btu/lb. In other embodiments, the thermal coke replacement product further comprises about 0.5 wt % to about 50 wt % volatile matter. The thermal coal or coke replacement product may include about 0.4 wt % to about 15 wt % moisture.

In some embodiments, a biogenic reagent is useful as a petroleum (pet) coke or calcine pet coke replacement product. Calcine pet coke is generally characterized as having at least about 66 wt % carbon, up to 4.6 wt % sulfur, up to about 5.5 wt % volatile matter, up to about 19.5 wt % ash, and up to about 2 wt % moisture, and is typically sized at about 3 mesh or less. In some embodiments, the calcine pet coke replacement product is a biogenic reagent comprising at least about 66 wt % carbon, not more than about 4.6 wt % sulfur, not more than about 19.5 wt % ash, not more than about 2 wt % moisture, and is sized at about 3 mesh or less.

In some embodiments, a biogenic reagent is useful as a coking carbon replacement carbon (e.g., co-fired with metallurgical coal in a coking furnace). In one embodiment, a coking carbon replacement product is a biogenic reagent comprising at least about 55 wt % carbon, not more than about 0.5 wt % sulfur, not more than about 8 wt % non-combustible material, and a heat value of at least about 11,000 Btu per pound. In some embodiments, the coking carbon replacement product comprises about 0.5 wt % to about 50 wt % volatile matter, and/or one or more additives.

Some variations utilize the biogenic reagents as carbon breeze products, which typically have very fine particle sizes such as 6 mm, 3 mm, 2 mm, 1 mm, or smaller. In some embodiments, a biogenic reagent according to the present invention is useful as a coke breeze replacement product. Coke breeze is generally characterized as having a maximum dimension of not more than about 6 mm, a carbon content of at least about 80 wt %, 0.6 to 0.8 wt % sulfur, 1% to 20 wt % volatile matter, up to about 13 wt % ash, and up to about 13 wt % moisture. In some embodiments, a coke breeze replacement product is a biogenic reagent according to the present invention comprising at least about 80 wt % carbon, not more than about 0.8 wt % sulfur, not more than about 20 wt % volatile matter, not more than about 13 wt % ash, not more than about 13 wt % moisture, and a maximum dimension of about 6 mm.

Particle sizes may be measured by a variety of techniques, including dynamic light scattering, laser diffraction, image analysis, or sieve separation, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images. Finally, sieving is a conventional technique of separating particles by size.

In some embodiments, a biogenic reagent is useful as a carbon breeze replacement product during, for example, taconite pellet production or in an iron-making process.

Some variations utilize the biogenic reagents, or the calcined biocoke, as feedstocks for various fluidized beds, or as fluidized-bed carbon-based feedstock replacement products. The carbon may be employed in fluidized beds for total combustion, partial oxidation, gasification, steam reforming, or the like. The carbon may be primarily converted into syngas for various downstream uses, including production of energy (e.g., combined heat and power), or liquid fuels (e.g., methanol or Fischer-Tropsch diesel fuels).

In some embodiments, a biogenic reagent according is useful as a fluidized-bed coal replacement product in, for example, fluidized bed furnaces wherever coal would be used (e.g., for process heat or energy production).

Some variations utilize the biogenic reagents as carbon-based furnace addition products. Coal-based carbon furnace addition products are generally characterized as having high sulfur levels, high phosphorus levels, and high ash content, which contribute to degradation of the metal product and create air pollution. In some embodiments, a carbon furnace addition replacement product comprising a biogenic reagent comprises not more than about 0.5 wt % sulfur, not more than about 4 wt % ash, not more than about 0.03 wt % phosphorous, and a maximum dimension of about 7.5 cm. In some embodiments, the carbon furnace addition replacement product replacement product comprises about 0.5 wt % to about 50 wt % volatile matter and about 0.4 wt % to about 15 wt % moisture.

In some embodiments, the calcined biocoke is useful as a furnace addition carbon product at, for example, basic oxygen furnace or electric arc furnace facilities wherever carbon is used. For example, furnace addition carbon may be added to scrap steel during steel manufacturing at electric-arc furnace facilities. For electric-arc furnace applications, high-purity carbon is desired so that impurities are not introduced back into the process following earlier removal of impurities. In some embodiments, a furnace addition carbon product comprises at least about 80 wt % carbon, not more than about 0.5 wt % sulfur, not more than about 8 wt % non-combustible material, and a heat value of at least about 11,000 Btu per pound. In some embodiments, the furnace addition carbon product further comprises up to about 5 wt % manganese, up to about 5 wt % fluorospar, about 5 wt % to about 10 wt % dolomite, about 5 wt % to about 10 wt % dolomitic lime, and/or about 5 wt % to about 10 wt % calcium oxide.

Some variations utilize the biogenic reagents as stoker furnace carbon-based products. In some embodiments, a biogenic reagent according to the present invention is useful as a stoker coal replacement product at, for example, stoker furnace facilities wherever coal would be used (e.g., for process heat or energy production).

Some variations utilize the biogenic reagents as injectable (e.g., pulverized) carbon-based materials. In some embodiments, a biogenic reagent is useful as an injection-grade calcine pet coke replacement product. Injection-grade calcine pet coke is generally characterized as having at least about 66 wt % carbon, about 0.55 to about 3 wt % sulfur, up to about 5.5 wt % volatile matter, up to about 10 wt % ash, up to about 2 wt % moisture, and is sized at about 6 mesh or less. In some embodiments, a calcine pet coke replacement product is a biogenic reagent comprising at least about 66 wt % carbon, not more than about 3 wt % sulfur, not more than about 10 wt % ash, not more than about 2 wt % moisture, and is sized at about 6 mesh or less.

In some embodiments, a biogenic reagent is useful as an injectable carbon replacement product at, for example, basic oxygen furnace or electric arc furnace facilities in any application where injectable carbon would be used (e.g., injected into slag or ladle during steel manufacturing).

In some embodiments, a biogenic reagent is useful as a pulverized carbon replacement product, for example, wherever pulverized coal would be used (e.g., for process heat or energy production). In some embodiments, the pulverized coal replacement product comprises up to about 10 percent calcium oxide.

Some variations utilize the biogenic reagents as carbon addition product for metals production. In some embodiments, a biogenic reagent according to the present invention is useful as a carbon addition product for production of carbon steel or another metal alloy comprising carbon. Coal-based late-stage carbon addition products are generally characterized as having high sulfur levels, high phosphorous levels, and high ash content, and high mercury levels which degrade metal quality and contribute to air pollution. In some embodiments of this invention, the carbon addition product comprises not more than about 0.5 wt % sulfur, not more than about 4 wt % ash, not more than about 0.03 wt % phosphorus, a minimum dimension of about 1 to 5 mm, and a maximum dimension of about 8 to 12 mm.

Some variations of the invention utilize the biogenic reagents as catalyst supports. Carbon is a known catalyst support in a wide range of catalyzed chemical reactions, such as mixed-alcohol synthesis from syngas using sulfided cobalt-molybdenum metal catalysts supported on a carbon phase, or iron-based catalysts supported on carbon for Fischer-Tropsch synthesis of higher hydrocarbons from syngas.

Some variations utilize the biogenic reagents as activated carbon products. Activated carbon is used in a wide variety of liquid and gas-phase applications, including water treatment, air purification, solvent vapor recovery, food and beverage processing, and pharmaceuticals. For activated carbon, the porosity and surface area of the material are generally important. The biogenic reagent provided herein may provide a superior activated carbon product, in various embodiments, due to (i) greater surface area than fossil-fuel based activated carbon; (ii) carbon renewability; (iii) vascular nature of biomass feedstock in conjunction with additives better allows penetration/distribution of additives that enhance pollutant control; and (iv) less inert material (ash) leads to greater reactivity.

It should be recognized that in the above description of market applications of biogenic reagents, the described applications are not exclusive, nor are they exhaustive. Thus a biogenic reagent that is described as being suitable for one type of carbon product may be suitable for any other application described, in various embodiments. These applications are exemplary only, and there are other applications of biogenic reagents.

In addition, in some embodiments, the same physical material may be used in multiple market processes, either in an integrated way or in sequence. Thus, for example, a biogenic reagent that is used as a carbon electrode or an activated carbon may, at the end of its useful life as a performance material, then be introduced to a combustion process for energy value or to a metal-making (e.g., metal ore reduction) process, etc.

### Conversion of Biocarbon to Reducing Gas

Some variations utilize biocarbon to generate a reducing gas, wherein the reducing gas may be fed to the biocoking reactor and/or may be recovered and sold.

The optional production of reducing gas (also referred to herein as “bio-reductant gas”) will now be further described. The conversion of biocarbon to reducing gas takes place in a reactor, which may be referred to as a bio-reductant formation unit.

A reactant may be employed to react with the biocarbon and produce a reducing gas. The reactant may be selected from oxygen, steam, or a combination thereof. In some embodiments, oxygen is mixed with steam, and the resulting mixture is added to the second reactor. Oxygen or oxygen-enriched air can be added to cause an exothermic reaction such as the partial or total oxidation of carbon with oxygen; to achieve a more favorable H₂/CO ratio in the reducing gas; (iii) to increase the yield of reducing gas; and/or (iv) to increase the purity of reducing gas, e.g. by reducing the amount of CO₂, pyrolysis products, tar, aromatic compounds, and/or other undesirable products.

Steam is a preferred reactant, in some embodiments. Steam (i.e. H₂O in a vapor phase) may be introduced into the reactor in one or more input streams. Steam may include steam generated by moisture contained in the biocarbon pellets, as well as steam generated by any chemical reactions that produce water.

All references herein to a “ratio” of chemical species are references to molar ratios unless otherwise indicated. For example, a H₂/CO ratio of 1 means one mole of hydrogen per mole of carbon dioxide.

Steam reforming, partial oxidation, water-gas shift (WGS), and/or combustion reactions can occur when oxygen or steam are added. Exemplary reactions are shown below with respect to a cellulose repeat unit (C₆H₁₀O₅) found, for example, in cellulosic feedstocks. Similar reactions can occur with any carbon-containing feedstock, including biocarbon pellets.

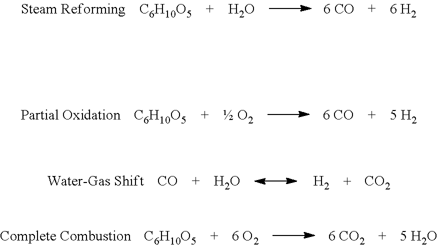

The bio-reductant formation unit is any reactor capable of causing at least one chemical reaction that produces reducing gas. Conventional steam reformers, well-known in the art, can be used either with or without a catalyst. Other possibilities include autothermal reformers, partial-oxidation reactors, and multistaged reactors that combine several reaction mechanisms (e.g., partial oxidation followed by water-gas shift). The reactor configuration can be a fixed bed, a fluidized bed, a plurality of microchannels, or some other configuration.

In some embodiments, the total amount of steam as reactant is at least about 0.1 mole of steam per mole of carbon in the feed material. In various embodiments, at least about any of 0.5, 1.0, 1.5, 2.0, 3.0, 4.0, 5.0, or more moles of steam are added or are present per mole of carbon. In some embodiments, between about 1.5-3.0 moles of steam are added or are present per mole carbon.

The amount to steam that is added to the second reactor may vary depending on factors such as the conditions of the pyrolysis reactor. When pyrolysis produces a carbon-rich solid material, generally more steam (and/or more oxygen) is used to add the necessary H and O atoms to the C available to generate CO and H₂. From the perspective of the overall system, the moisture contained in the biocarbon pellets can be accounted for in determining how much additional water (steam) to add in the process.

Exemplary ratios of oxygen to steam (O₂/H₂O) are equal to or less than about any of 2, 1.5, 1, 0.5, 0.2, 0.1, 0.05, 0.02, 0.01, or less, in the second reactor. When the ratio of O₂/H₂O is greater than 1, the combustion reaction starts to dominate over partial oxidation, which may produce undesirably low CO/CO₂ ratios.

In some embodiments, oxygen without steam is used as the reactant. Oxygen can be added in substantially pure form, or it can be fed to the process via the addition of air, optionally enriched with oxygen. In some embodiments, air that is not enriched with oxygen is added. In other embodiments, enriched air from an off-spec or recycle stream, which may be a stream from a nearby air-separation plant, for example, can be used. In some embodiments, the use of enriched air with a reduced amount of N₂ (i.e., less than 79 vol %) results in less N₂ in the resulting reducing gas. Because removal of N₂ can be expensive, methods of producing reducing gas with less or no N₂ are typically desirable.

In some embodiments, the presence of oxygen alters the ratio of H₂/CO in the reducing gas, compared to the ratio produced by the same method in the absence of oxygen. The H₂/CO ratio of the reducing gas can be between about 0.5 to about 2.0, such as between about 0.75-1.25, about 1-1.5, or about 1.5-2.0. As will be recognized, increased water-gas shift (by higher rates of steam addition) will tend to produce higher H₂/CO ratios, such as at least 2.0, 3.0. 4.0. 5.0, or even higher, which may be desired for certain applications, including hydrogen production.

Catalysts may optionally be utilized in the reactor for generating the reducing gas. Catalysts may include, but are not limited to, alkali metal salts, alkaline earth metal oxides and salts, mineral substances or ash in coal, transition metals and their oxides and salts, and eutectic salt mixtures. Specific examples of catalysts include, but are not limited to, potassium hydroxide, potassium carbonate, lithium hydroxide, lithium carbonate, cesium hydroxide, nickel oxide, nickel-substituted synthetic mica montmorillonite (NiSMM), NiSMM-supported molybdenum, iron hydroxyoxide, iron nitrate, iron-calcium-impregnated salts, nickel uranyl oxide, sodium fluoride, and cryolite.

Other exemplary catalysts include, but are not limited to, nickel, nickel oxide, rhodium, ruthenium, iridium, palladium, and platinum. Such catalysts can be coated or deposited onto one or more support materials, such as, for example, gamma-alumina (optionally doped with a stabilizing element such as magnesium, lanthanum, or barium).

Before being added to the system, any catalyst can be pretreated or activated using known techniques that impact total surface area, active surface area, site density, catalyst stability, catalyst lifetime, catalyst composition, surface roughness, surface dispersion, porosity, density, and/or thermal diffusivity. Pretreatments of catalysts include, but are not limited to, calcining, washcoat addition, particle-size reduction, and surface activation by thermal or chemical means.

Catalyst addition can be performed by first dissolving or slurrying the catalyst(s) into a solvent such as water or any hydrocarbon that can be gasified and/or reformed. In some embodiments, the catalyst is added by direct injection of such a slurry into a vessel. In some embodiments, the catalyst is added to steam and the steam/catalyst mixture is added to the system. In these embodiments, the added catalyst may be at or near its equilibrium solubility in the steam or may be introduced as particles entrained in the steam and thereby introduced into the system.

Material can generally be conveyed into and out of the reactor by single screws, twin screws, rams, and the like. Material can be conveyed mechanically by physical force (metal contact), pressure-driven flow, pneumatically driven flow, centrifugal flow, gravitational flow, fluidized flow, or some other known means of moving solid and gas phases. It may be preferable to utilize a fixed bed of biocarbon pellets in the reactor, especially in embodiments that employ a bed of metal oxide disposed above the biocarbon pellet bed which need to be mechanically robust.

In some embodiments, the reactor employs gasification of biocarbon pellets to generate a reducing gas. Gasification is carried out at elevated temperatures, typically about 600° C. to about 1100° C. Less-reactive biogenic reagents require higher operating temperatures. The amount of reactant introduced (e.g., air, oxygen, enriched air, or oxygen-steam mixtures) will typically be the primary factor controlling the gasification temperature. Operating pressures from atmospheric to about 50 bar have been employed in biomass gasification. Gasification also requires a reactant, commonly air, high-purity oxygen, steam, or some mixture of these gases.

Gasifiers may be differentiated based on the means of supporting solids within the vessel, the directions of flow of both solids and gas, and the method of supplying heat to the reactor. Whether the gasifier is operated at near atmospheric or at elevated pressures, and the gasifier is air-blown or oxygen-blown, are also distinguishing characteristics. Common classifications are fixed-bed updraft, fixed-bed downdraft, bubbling fluidized bed, and circulating fluidized bed.

Fixed-bed gasifiers, in general, cannot handle fibrous herbaceous feedstocks, such as wheat straw, corn stover, or yard wastes. However, in the disclosed processes, biomass is first pyrolyzed to a biogenic reagent, which is pelletized, and the biocarbon pellets may be gasified. The biocarbon pellets may be directly gasified using a fixed-bed gasifier, without necessarily reducing the size of the pellets.

Circulating fluidized-bed gasification technology is available from Lurgi and Foster Wheeler, and represents the majority of existing gasification technology utilized for biomass and other wastes. Bubbling fluidized-bed gasification (e.g., U-GAS® technology) has been commercially used.

Directly heated gasifiers conduct endothermic and exothermic gasification reactions in a single reaction vessel; no additional heating is needed. In contrast, indirectly heated gasifiers require an external source of heat. Indirectly heated gasifiers commonly employ two vessels. The first vessel gasifies the feed with steam (an endothermic process). Heat is supplied by circulating a heat-transfer medium, commonly sand. Reducing gas and solid char produced in the first vessel, along with the sand, are separated. The mixed char and sand are fed to the second vessel, where the char is combusted with air, heating the sand. The hot sand is circulated back to the first vessel.

The biocarbon pellets may be introduced to a gasifier as a “dry feed” (optionally with moisture, but no free liquid phase), or as a slurry or suspension in water. Dry-feed gasifiers typically allow for high per-pass carbon conversion to reducing gas and good energy efficiency. In a dry-feed gasifier, the energy released by the gasification reactions can cause the gasifier to reach extremely high temperatures. This problem may be resolved by using a wet-wall design.

In some embodiments, the feed to the gasifier is biocarbon pellets with high hydrogen content. The resulting reducing gas is relatively rich in hydrogen, with high H₂/CO ratios, such as H₂/CO>1.5 or more.

In some embodiments, the feed to the gasifier is biocarbon pellets with low hydrogen content. The resulting reducing gas is expected to have relatively low H₂/CO ratios. For downstream processes that require H₂/CO>1, it may be desirable to inject water or steam into the gasifier to both moderate the gasifier temperature (via sensible-heat effects and/or endothermic chemistry), and to shift the H₂/CO ratio to a higher, more-desirable ratio. Water addition can also contribute to temperature moderation by endothermic consumption, via steam-reforming chemistry. In steam reforming, H₂O reacts with carbon or with a hydrocarbon, such as tar or benzene/toluene/xylenes, to produce reducing gas and lower the adiabatic gasification temperature.

In certain variations, the gasifier is a fluidized-bed gasifier, such as a bubbling fluidized gasification reactor. Fluidization results in a substantially uniform temperature within the gasifier bed. A fluidizing bed material, such as alumina sand or silica sand, can reduce potential attrition issues. The gasifier temperature is preferably moderated to a sufficiently low temperature so that ash particles do not begin to transform from solid to molten form, which can cause agglomeration and loss of fluidization within the gasifier.

When a fluidized-bed gasifier is used, the total flow rate of all components should ensure that the gasifier bed is fluidized. The total gas flow rate and bed diameter establish the gas velocity through the gasifier. The correct velocity must be maintained to ensure proper fluidization.

In variations, the gasifier type may be entrained-flow slagging, entrained flow non-slagging, transport, bubbling fluidized bed, circulating fluidized bed, or fixed bed. Some embodiments employ gasification catalysts.

Circulating fluidized-bed gasifiers may be employed, wherein gas, sand, and feedstock (e.g., crushed or pulverized biocarbon pellets) move together. Exemplary transport gases include recirculated product gas, combustion gas, or recycle gas. High heat-transfer rates from the sand ensure rapid heating of the feedstock, and ablation is expected to be stronger than with regular fluidized beds. A separator may be employed to separate the reducing gas from the sand and char particles. The sand particles may be reheated in a fluidized burner vessel and recycled to the reactor.

In some embodiments in which a countercurrent fixed-bed gasifier is used, the reactor consists of a fixed bed of a feedstock through which a gasification agent (such as steam, oxygen, and/or recycle gas) flows in countercurrent configuration. The ash is either removed dry or as a slag.

In some embodiments in which a co-current fixed-bed gasifier is used, the reactor is similar to the countercurrent type, but the gasification agent gas flows in co-current configuration with the feedstock. Heat is added to the upper part of the bed, either by combusting small amounts of the feedstock or from external heat sources. The produced gas leaves the reactor at a high temperature, and much of this heat is transferred to the gasification agent added in the top of the bed, resulting in good energy efficiency.

In some embodiments in which a fluidized-bed reactor is used, the feedstock is fluidized in recycle gas, oxygen, air, and/or steam. The ash may be removed dry or as heavy agglomerates that defluidize. Recycle or subsequent combustion of solids can be used to increase conversion. Fluidized-bed reactors are useful for feedstocks that form highly corrosive ash that would damage the walls of slagging reactors.

In some embodiments in which an entrained-flow gasifier is used, biocarbon pellets are pulverized and gasified with oxygen, air, or recycle gas in co-current flow. The gasification reactions take place in a dense cloud of very fine particles. High temperatures may be employed, thereby providing for low quantities of tar and methane in the reducing gas.

Entrained-flow reactors remove the major part of the ash as a slag, as the operating temperature is typically well above the ash fusion temperature. A smaller fraction of the ash is produced either as a very fine dry fly ash or as a fly-ash slurry. Certain entrained-bed reactors have an inner water- or steam-cooled wall covered with partially solidified slag.

The gasifier chamber can be designed, by proper configuration of the freeboard or use of internal cyclones, to keep the carryover of solids downstream operations at a level suitable for recovery of heat. Unreacted carbon can be drawn from the bottom of the gasifier chamber, cooled, and recovered.

A gasifier may include one or more catalysts, such as catalysts effective for partial oxidation, reverse water-gas shift, or dry (CO₂) reforming of carbon-containing species.

In some embodiments, a bubbling fluid-bed devolatilization reactor is utilized. The reactor is heated, at least in part, by the hot recycle gas stream to approximately 600° C.—below the expected slagging temperature. Steam, oxygen, or air may also be introduced to the second reactor. The second can be designed, by proper configuration of a freeboard or use of internal cyclones, to keep the carryover of solids at a level suitable for recovery of heat downstream. Unreacted char can be drawn from the bottom of the devolatilization chamber, cooled, and then fed to a utility boiler to recover the remaining heating value of this stream.

When a fluidized-bed gasifier is employed, the feedstock can be introduced into a bed of hot sand fluidized by a gas, such as recycle gas. Reference herein to “sand” shall also include similar, substantially inert materials, such as glass particles, recovered ash particles, and the like. High heat-transfer rates from fluidized sand can result in rapid heating of the feedstock. There can be some ablation by attrition with the sand particles. Heat may be provided by heat-exchanger tubes through which hot combustion gas flows.

Circulating fluidized-bed reactors can be employed, wherein gas, sand, and feedstock move together. Exemplary transport gases include recirculated product gas, combustion gas, or recycle gas. High heat-transfer rates from the sand ensure rapid heating of the feedstock, and ablation is expected to be stronger than with regular fluidized beds. A separator may be employed to separate the reducing gas from the sand and char particles. The sand particles can be reheated in a fluidized burner vessel and recycled to the reactor.

In some embodiments in which a countercurrent fixed-bed reactor is used, the reactor consists of a fixed bed of a feedstock through which a gasification agent (such as steam, oxygen, and/or recycle gas) flows in countercurrent configuration. The ash is either removed dry or as a slag.

In some embodiments in which a co-current fixed-bed reactor is used, the reactor is similar to the countercurrent type, but the gasification agent gas flows in co-current configuration with the feedstock. Heat is added to the upper part of the bed, either by combusting small amounts of the feedstock or from external heat sources. The reducing gas leaves the reactor at a high temperature, and much of this heat is transferred to the reactants added in the top of the bed, resulting in good energy efficiency. Since tars pass through a hot bed of carbon in this configuration, tar levels are expected to be lower than when using the countercurrent type.

In some embodiments in which a fluidized-bed reactor is used, the feedstock is fluidized in recycle gas, oxygen, air, and/or steam. The ash is removed dry or as heavy agglomerates that defluidize. Recycle or subsequent combustion of solids may be used to increase conversion.

To enhance heat and mass transfer, water may be introduced into the reactor using a nozzle, which is generally a mechanical device designed to control the direction or characteristics of a fluid flow as it enters an enclosed chamber or pipe via an orifice. Nozzles are capable of reducing the water droplet size to generate a fine spray of water. Nozzles may be selected from atomizer nozzles (similar to fuel injectors), swirl nozzles which inject the liquid tangentially, and so on.

Water sources may include direct piping from process condensate, other recycle water, wastewater, make-up water, boiler feed water, city water, and so on. Water may optionally first be cleaned, purified, treated, ionized, distilled, and the like. When several water sources are used, various volume ratios of water sources are possible. In some embodiments, a portion or all of the water for the second reactor is wastewater.

In some variations, the reducing gas is filtered, purified, or otherwise conditioned prior to being converted to another product. For example, cooled reducing gas may be introduced to a conditioning unit, where benzene, toluene, ethyl benzene, xylene, sulfur compounds, nitrogen, metals, and/or other impurities are optionally removed from the reducing gas.

Some embodiments include a reducing-gas cleanup unit. The reducing-gas cleanup unit is not particularly limited in its design. Exemplary reducing-gas cleanup units include cyclones, centrifuges, filters, membranes, solvent-based systems, and other means of removing particulates and/or other specific contaminants. In some embodiments, an acid-gas removal unit is included and may be any means known in the art for removing H₂S, CO₂, and/or other acid gases from the reducing gas.

The reducing gas produced as described according to the present disclosure may be utilized in a number of ways. Reducing gas can generally be chemically converted and/or purified into hydrogen, carbon monoxide, methane, olefins (such as ethylene), oxygenates (such as dimethyl ether), alcohols (such as methanol and ethanol), paraffins, and other hydrocarbons. Reducing gas can be converted into linear or branched C₅-C₁₅ hydrocarbons, diesel fuel, gasoline, waxes, or olefins by Fischer-Tropsch chemistry; mixed alcohols by a variety of catalysts; isobutane by isosynthesis; ammonia by hydrogen production followed by the Haber process; aldehydes and alcohols by oxosynthesis; and many derivatives of methanol including dimethyl ether, acetic acid, ethylene, propylene, and formaldehyde by various processes. The reducing gas can also be converted to energy using energy-conversion devices such as solid-oxide fuel cells, Stirling engines, micro-turbines, internal combustion engines, thermo-electric generators, scroll expanders, gas burners, or thermo-photovoltaic devices.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

All publications, patents, and patent applications cited in this specification are herein incorporated by reference in their entirety as if each publication, patent, or patent application were specifically and individually put forth herein.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially.

Therefore, to the extent there are variations of the invention, which are within the spirit of the disclosure or equivalent to the inventions found in the appended claims, it is the intent that this patent will cover those variations as well. The present invention shall only be limited by what is claimed.

What is claimed is:

1. A process for producing a renewable biocoke product from a bioliquid feedstock, the process comprising:
(a) providing a bioliquid feedstock;
(b) providing a recycled biocoke;
(c) feeding the bioliquid feedstock and the recycled biocoke into a biocoking reactor;
(d) feeding a reducing gas into the biocoking reactor, wherein the reducing gas contains H₂ and/or CO;
(e) within the biocoking reactor, chemically converting the bioliquid feedstock into biocoke by thermally cracking molecules of the bioliquid feedstock and nucleating the biocoke on particles of the recycled biocoke as a biocoking template, wherein the reducing gas reacts with at least some oxygen present in the bioliquid feedstock to form H₂O and/or CO₂;
(f) within a devolatilization unit, devolatilizing the biocoke to generate a devolatilized biocoke;
(g) within a calcination unit, or within the devolatilization unit, calcining the devolatilized biocoke to generate a calcined biocoke;
(h) recovering a portion of the biocoke, a portion of the devolatilized biocoke, a portion of the calcined biocoke, or a combination thereof, as the recycled biocoke for use in step (b); and
(i) recovering the calcined biocoke as a renewable biocoke product.

2. The process of claim 1, wherein the bioliquid feedstock is obtained from condensing and optionally fractionating a pyrolysis vapor from biomass pyrolysis.

3. The process of claim 1, wherein the bioliquid feedstock and the recycled biocoke are pre-mixed in a heated mixing unit prior to feeding to the biocoking reactor.

4. The process of claim 1, wherein the reducing gas is obtained from collecting and optionally fractionating and/or treating a non-condensable gas stream from biomass pyrolysis.

5. The process of claim 1, wherein the reducing gas contains at least some H₂.

6. The process of claim 1, wherein the reducing gas contains at least some CO.

7. The process of claim 1, wherein the biocoking reactor is a screw coker reactor.

8. The process of claim 1, wherein a coking catalyst is added to the biocoking reactor.

9. The process of claim 1, wherein a hydrodeoxygenation catalyst is added to the biocoking reactor.

10. The process of claim 1, wherein the biocoking reactor is operated at a biocoking temperature from about 200° C. to about 750° C.

11. The process of claim 1, wherein the biocoking reactor is operated at a biocoking pressure from about 100 kPa to about 1000 kPa.

12. The process of claim 1, wherein the devolatilization unit, in step (f), is operated at a devolatilization temperature from about 450° C. to about 1000° C.

13. The process of claim 1, wherein the devolatilization unit is operated in a substantially inert-gas atmosphere.

14. The process of claim 1, wherein the calcination unit, in step (g), is operated at a calcination temperature from about 1000° C. to about 1800° C.

15. The process of claim 1, wherein the calcination unit is operated in a substantially inert-gas atmosphere.

16. The process of claim 1, wherein steps (f) and (g) are combined and carried out in a single unit consisting of the devolatilization unit.

17. The process of claim 1, wherein steps (f) and (g) are conducted separately, within the devolatilization unit and the calcination unit, respectively.

18. The process of claim 1, wherein the weight ratio of the bioliquid feedstock to the recycled biocoke is selected from about 1 to about 10.

19. The process of claim 1, wherein the bioliquid feedstock includes a condensate stream obtained from condensing a vapor released from the biocoking reactor, a vapor released from the devolatilization unit, or a combined vapor from both the biocoking reactor and the devolatilization unit.

20. The process of claim 1, wherein the renewable biocoke product contains at least 80 wt % total carbon.

21. The process of claim 1, wherein the renewable biocoke product contains at least 90 wt % total carbon.

22. The process of claim 1, wherein the renewable biocoke product is at least 90% renewable, according to a measurement of the ¹⁴C/¹²C isotopic ratio of the renewable biocoke product.

23. The process of claim 1, wherein the renewable biocoke product is 100% renewable, according to a measurement of the ¹⁴C/¹²C isotopic ratio of the renewable biocoke product.

24. The process of claim 1, wherein the renewable biocoke product contains at least 50 wt % crystalline graphite according to spectroscopy.

25. The process of claim 1, wherein the renewable biocoke product contains at least 75 wt % crystalline graphite according to spectroscopy.

26. The process of claim 1, wherein the renewable biocoke product contains at least 90 wt % crystalline graphite according to spectroscopy.

27. The process of claim 1, wherein the process is operated continuously or semi-continuously.

28. The process of claim 1, the process further comprising fabricating an electrode containing the renewable biocoke product.

29. The process of claim 28, wherein the electrode is a metal-making electrode utilized in electric arc furnace metal production.

30. The process of claim 28, wherein the electrode is a battery electrode.
